(19) United States
(12) Patent Application Publication
(10) Pub. No.: US 2005/0226303 A1
(43) Pub. Date: Oct. 13, 2005

(54) Solid-state laser pumped by semiconductor laser array

(76) Inventors: Tsuyoshi Suzudo, Miyagi (JP); Takunori Taira, Aichi (JP)

Correspondence Address: DICKSTEIN SHAPIRO MORIN & OSHINSKY LLP, 2101 L Street, NW, Washington, DC, 20037, US

(21) Appl. No.: 11/091,542

(22) Filed: Mar. 29, 2005

(30) Foreign Application Priority Data
Mar. 30, 2004 (JP) 2004-098117
Jun. 30, 2004 (JP) 2004-194594
Jan. 31, 2005 (JP) 2005-023354
Mar. 8, 2005 (JP) 2005-064649

(51) Int. Cl. H01S 3/091

(52) U.S. Cl. 372/75; 372/50.1

(57) ABSTRACT

A solid-state laser apparatus includes a solid-state laser medium producing an output laser beam, the solid-state laser medium forming a microchip laser and having opposing end surfaces forming a laser cavity, a semiconductor laser array pumping the solid-state laser medium by a pumping laser beam, the semiconductor laser array injecting the pumping laser beam to the solid-state laser medium from a direction perpendicular to a direction of the output laser beam, the solid-state laser medium and the semiconductor laser array are mounted on a common mounting substrate.

### BACKGROUND OF THE INVENTION

The present invention relates in general to laser technology and more particularly to a solid-state laser pumped by a semiconductor laser. More specifically, the present invention relates to a solid-state laser pumped by semiconductor lasers and equipped with a wavelength-conversion element. Such a semiconductor laser can oscillate at plural, different wavelengths and is applicable to laser printers, laser scanning display devices, laser projectors, and the like.

Recently, various apparatuses that use laser beam are put into practical use. Such apparatuses include optical disk apparatuses, laser printers, laser instruments, and the like. Further, investigations are being made for laser display devices in the prospect of future practical use.

In these applications, there exist various demands such as shortening of the laser oscillation wavelength, providing of three primary colors (red, blue, green), and the like. Thus, development of semiconductor lasers and wavelength-conversion lasers are being made in view of these various demands. Particularly, intensive efforts are being made on the wavelength-conversion optical source that uses a solid-state laser in relation to the applications that require high laser output such as 10 watts.

In the applications of laser optical source such as a laser display device, size reduction of the laser optical source is inevitable. Further, in these applications, it is ideal that the optical source can provide the laser output in the wavelengths of three primary colors with large luminance. Higher the laser output, the wider the application of the optical source.

Further, in the applications of the laser optical source for optical projection systems such as laser projectors, it is advantageous that the optical source produces the three primary color laser beams with optical axes aligned as closely as possible for better optical performance. In view of this, it is preferable in such an optical source that the points of optical emission are disposed as closely as possible. Further, it is preferable that the lasers used for these applications are provided with as low cost as possible.

For the laser optical source of high-luminosity, it is preferable to use a solid-state laser. Hereinafter, conventional laser optical sources will be reviewed.

Patent Reference 1 discloses a laser optical source that provides a high laser output by arraying solid-state lasers. More specifically, this prior art teaches arraying of microchip lasers each using a single laser crystal doped with Nd.

On the other hand, the optical source of this prior art, relying on the mechanism of heat dissipation conducted from an edge of a sapphire substrate for cooling the laser crystal, has a drawback of limited efficiency of heat dissipation, and it is difficult to obtain large laser output. Thus, in order to provide large optical output, it becomes necessary with this prior art to increase the number of the lasers. However, such increase of the number of the lasers inevitably increases the size of the optical source.

Patent Reference 2 provides another conventional optical source.

With this second prior art, there is provided a region in a disk-shaped laser crystal such that the laser crystal is doped with a rare earth element in such a region for higher laser output of the solid-state laser. Thereby, the laser pumping is made from a lateral direction by using semiconductor lasers. Because this prior art can achieve efficient heat dissipation from the laser crystal, the optical source can achieve high output power.

On the other hand, this prior art has a drawback, associated with its use of laser output mirror, in that the size of the optical source cannot be reduced. Further, because it is necessary with this prior art laser optical source to irradiate a pumping optical beam selectively to the region where the rare earth element has been added, and associated with this, various complex problems are caused in relation to the optical system used for the pumping optical beam or in relation to the shape of the laser crystal. Thus, it is difficult with this prior art to reduce the cost of the optical source.

Patent Reference 3 teaches another conventional laser optical source.

In this third prior art, too, high optical output is realized by using a laser crystal of disk-shaped form and by applying efficient cooling to the laser crystal.

However, this conventional art also uses laser mirrors, and it is not possible to reduce the size of the optical source. Further, because this prior art causes the pumping of the disk-shaped laser crystal for the entirety thereof, it is not possible to increase the efficiency of wavelength conversion.

In addition, this prior art has a drawback, in relation to its construction of pumping the disk-shaped laser crystal as a whole, in that overlapping of the laser oscillation region and the pumping region in the laser crystal (mode matching efficiency) cannot be increased when the pumping is made from the lateral direction. Thereby, the efficiency of the laser oscillation is degraded.

While this drawback may be resolved by providing a core part doped with the rare earths at the central part of the disk-shaped laser crystal, it is still difficult to reduce the size of the optical source as a whole in view of the pumping action made from the entire azimuth directions of the laser crystal and further in view of the construction in which the laser crystal and the pumping source are disposed with separation Heretofore, the conventional solid-state laser optical sources of single wavelength have been reviewed.

Hereinafter, the laser optical source of multiple wavelengths will be reviewed.

Patent Reference 4 shows a conventional multiple-wavelength laser optical source.

It should be noted that this laser optical source uses a surface-emission semiconductor laser array and changes the wavelength of individual laser elements constituting the array.

In the laser array of this prior art, it should be noted that each of the laser elements used for the optical source is formed of a surface-emission laser. Thus, the output power of the laser array is rather limited. Further, the variable range of the wavelength is limited by the bandgap. This means that the wavelength range of this optical source is limited and the use thereof for the application of projectors is not appropriate.

Patent Reference 5 shows a laser optical source for use in projectors, or the like.

More specifically, this prior art is an invention of a three-primary color optical source and is capable of providing the laser beams of three primary colors by mounting surface-emission semiconductor lasers of respective colors on a substrate.

However, this prior art suffers from the problems in that, while it is certainly possible to form three-primary color laser beams with this prior art, the output power thereof is limited because of the use of semiconductor lasers, and it becomes necessary to mount a large number of semiconductor lasers for obtaining large output power. However, the use of semiconductor lasers with large number increases the complexity of construction of the optical source and raises a further problem of handling a large number of laser beams. Thereby, designing of the optical system becomes inevitably complex.

Thus, there exists no known high-luminosity laser optical source of compact size and still capable of providing high output power. Further, there is no known construction of compact and high-power laser optical source that can reduce the cost thereof. Further, there exists no known construction for providing the laser beams of plural wavelengths simultaneously such that the laser beams of different wavelengths are formed with reduced spatial separation in the same unit.

### REFERENCES

(Patent Reference 1) Japanese Laid-Open Patent Application 8-307017
(Patent Reference 2) Japanese Laid-Open Patent Application 2002-141535
(Patent Reference 3) U.S. Pat. No. 5,553,088
(Patent Reference 4) Japanese Laid-Open Patent Application 2000-58958
(Patent Reference 5) Japanese Laid-Open Patent Application 7-22706

### SUMMARY OF THE INVENTION

Accordingly, it is a general object of the present invention to provide a novel and useful solid-state laser apparatus wherein the foregoing problems are eliminated.

Another and more specific object of the present invention is to provide a high-power solid-state laser apparatus pumped by a semiconductor laser and capable of providing plural laser beams of different wavelengths in a visible wavelength band, such that there is caused efficient laser oscillation and such that the solid-state laser apparatus can be formed with low cost in the form of compact package.

Another object of the present invention is to provide a compact and high-power solid-state laser apparatus of the type noted above such that the laser apparatus has a microchip construction characterized by a compact cavity size and realizes highly efficient laser excitation by causing the optical pumping by using a semiconductor laser array as a pumping optical source, the optical pumping of the solid-state laser being achieved in the direction perpendicular to the direction in which the output laser beam is produced for improving the heat resistance of the material constituting the solid-state laser, the laser apparatus having the construction suitable for assembling and mounting with low cost by using an automated facility by arranging and mounting the solid-state laser and the semiconductor laser array on a common mounting substrate. It should be noted that the present invention seeks for the construction capable of forming the solid-state laser apparatus in the form of a compact package by using the foregoing construction.

Another object of the present invention is to provide a solid-state laser apparatus having plural solid-state laser media each having the construction of a microchip laser, such that the respective laser media have mutually different wavelengths in correspondence to plural output wavelengths of the solid-state laser apparatus.

Another object of the present invention is to achieve cost reduction in the solid-state laser apparatus of the type noted before, by forming plural microchip lasers on a single solid-laser medium with respective, different wavelengths, such that the number of components is reduced together with the cost of the material and the number of the assembling steps, while realizing at the same time laser oscillation at different wavelengths.

Another object of the present invention is to provide a solid-state laser apparatus of the type noted before in which the efficiency of dissipating the heat formed in the solid-state laser medium as a result of the optical pumping is improved and further the efficiency of mode matching is improved by way of limiting the laser oscillation region in the solid-state laser medium, by forming the solid-state laser medium to have a composite structure such that there is formed a laser oscillation region doped with an impurity element needed for laser oscillation and the region in which such impurity element is not doped.

Another object of the present invention is to provide a solid-state laser apparatus of the type noted before that uses the composite solid-state laser medium, wherein the composite solid-state laser medium comprises a single monocrystalline material. By doing so, it becomes possible to achieve high-quality laser output free from laser degradation just as in the case of a single crystal laser.

Another object of the present invention is to provide a solid-state laser apparatus of the type noted before that uses the composite solid-state laser medium, wherein the composite solid-state laser medium comprises a single ceramic material. By doing so, it becomes possible to use a material capable of mass producing with low cost and with uniform material characteristics for the laser medium, and it becomes possible to achieve laser output with little device-to-device variation.

Another object of the present invention is to provide a solid-state laser apparatus pumped by a semiconductor laser and using a composite solid-state laser medium, wherein the composite solid-state laser medium comprises a monocrystalline material region for the region causing laser oscillation doped with an impurity element needed for laser oscillation, while the region not doped with the foregoing impurities comprises a ceramic material of the material or different material to the monocrystalline material. According to the present invention, it becomes possible to achieve high-quality laser oscillation by using a monocrystalline medium in the region directly contributing to the laser oscillation while reducing the cost of the solid-state laser by using a ceramic material for the surrounding region. With this, it becomes possible to achieve both high-quality laser oscillation and low laser cost.

Another object of the present invention is to provide a solid-state laser apparatus pumped by a semiconductor laser and using a composite solid-state laser medium, wherein the solid-state laser medium comprises a ceramic material for the region where doping is made with the impurity element needed for laser oscillation and wherein the region not doped with the impurity element comprises a monocrystalline material of the same material or different material to the ceramic material. With this, it becomes possible to utilize the characteristics pertinent to the ceramic material such as improvement of oscillation efficiency. Further, it becomes possible to utilize a crystal suitable for heat dissipation for the surrounding region. Thereby, improvement of laser characteristics is achieved together with improved thermal stability.

Further, in order to achieve the foregoing objects, the present invention achieves pumping of the microchip laser by using the pumping laser radiation from a semiconductor laser array after dividing by using an optical element. By doing so, it becomes possible to use the same semiconductor laser array for plural microchip lasers, and it is no longer the need of providing individual layer arrays for the plural microchip lasers. Because the pumping is made by the common semiconductor laser array, optical excitation of the microchip lasers is achieved with improved stability. Further, the cost of the laser apparatus using such microchip lasers is reduced.

Further, the present invention achieves the foregoing objects by providing plural semiconductor laser arrays for laser excitation such that the excitation laser radiation for the respective microchip lasers are obtained by dividing the laser radiation from the foregoing plural semiconductor laser arrays by using optical elements. With this, the pumping power of the microchip lasers is increased, and the laser apparatus can provide a large output power.

Further, another object of the present invention is to provide a laser apparatus comprising plural microchip lasers and capable of providing visible laser output, by disposing a non-linear optical element in exiting optical paths of the individual microchip lasers for wavelength conversion.

In order to achieve the foregoing object, the present invention uses a quasi-phase matched wavelength conversion element for the non-linear optical element used for wavelength conversion. Thereby, it becomes possible to improve the efficiency of wavelength conversion easily by increasing the length of the non-linear optical element. Thereby, the present invention can provide highly efficient laser apparatus.

Further, in order to achieve this object, the present invention uses the quasi-phase matched wavelength conversion element in the form of an element including therein plural regions corresponding to the output laser beams of the plural microchip lasers. According to such a construction, there is used only one wavelength-conversion element, and the cost for the wavelength conversion element is reduced. Further, because of the reduction in the number of the parts, the assembling process of the laser apparatus is simplified, and the cost of the laser apparatus is reduced further.

Further, by producing the laser beams in any two or more of the three primary colors of red, green and blue, the laser apparatus of the present invention can be used for various image displaying apparatuses, printers, and the like.

Here, it should be noted that the solid-state laser material used with the laser apparatus of the present invention is a material having the absorption coefficient and cross-section of stimulated emission changing with the crystal orientation, and it is the object of the present invention to improve the efficiency of the laser apparatus by improving the efficiency of absorption of the pumping light beams and by improving the efficiency of laser oscillation by way of the use of a material emitting a linearly polarized radiation for the pumping optical source.

Another object of the present invention is to provide a laser apparatus of improved efficiency, by causing the direction of polarization of the pumping light beams emitted from the pumping semiconductor laser array to coincide with the direction of the crystal axis of the solid-state laser medium where a large absorption coefficient is attained and further parallel to the principal surface of the mounting substrate. Thereby, large optical absorption is achieved and the efficiency of utilization of the pumping light beams, and hence the efficiency of the laser apparatus, is improved.

In order to achieve the foregoing various objects, the pumping light beams emitted from the pumping semiconductor laser array enter into the solid-state laser medium from two opposing directions across the solid-state laser medium. With this, the optical power of pumping is increased and higher optical output is achieved for the laser apparatus of the present invention.

Another object of the present invention is to provide a solid-state laser apparatus pumped by a semiconductor laser array and having an optical cavity for producing a laser output, the solid-state laser comprising a solid-state laser medium forming a microchip, the microchip being defined by edge surfaces forming the optical cavity, the semiconductor laser array pumping the solid-state laser material from a direction perpendicular to a direction of an output laser beam, wherein the solid-state laser medium and the semiconductor laser array are disposed on a common mounting substrate.

In operation, the laser beams emitted from the semiconductor laser array are incident to the solid-state laser medium, and the optical radiation caused in the solid-state laser medium as a result of stimulated emission with the pumping laser beams from the semiconductor laser array forms a laser beam as it is reflected back and forth in the cavity formed inside the solid-state laser material. Thereby, a laser beam is emitted in the direction perpendicular to the direction of the pumping laser beams.

In a preferred embodiment, plural solid-state laser media each forming a microchip are provided on the same mounting substrate, such that the respective microchip lasers produce the laser beams of the respective, different wavelengths. Thus, the solid-state laser apparatus of the present embodiment produces plural laser beams of different wavelengths by respective optical cavities.

In another embodiment, the present invention provides a solid-state laser apparatus of the type noted before in which plural microchip lasers are formed on a single solid-state laser medium. With this embodiment, too, the laser beams of different wavelengths are obtained from the respective microchip lasers.

In another embodiment, the present invention provides a solid-state laser of the type noted before, in which the solid-state laser medium is formed of a composite solid-state medium including therein a region doped with an impurity element needed for laser oscillation and a region not doped with such an impurity element.

In another embodiment, the laser apparatus is the same as that of the previous embodiment, except that the composite solid-medium is formed of a single monocrystalline material.

In another embodiment, the composite solid-state laser medium comprises a single ceramic material.

In another embodiment, the composite solid-state laser medium comprises a first region of single crystal material doped with the impurity element needed for laser oscillation and a second region of a ceramic material of the same composition or different composition and not doped with an impurity element needed for laser oscillation.

In another embodiment, the composite solid-state medium comprises a first region formed of a ceramic material doped with an impurity element needed for laser oscillation and a second region of a monocrystalline material of the same or different composition and not doped with an impurity element needed for laser oscillation.

In another embodiment, an optical output of the microchip laser is the pumping laser beam produced by the semiconductor layer array and divided by an optical element.

In another embodiment, there are provided plural semiconductor laser arrays, and the microchip laser produces an optical output as the pumping laser beams produced by the plural semiconductor laser arrays divided by an optical element.

In another embodiment, the laser apparatus includes a non-linear optical element converting a wavelength in a path of an optical output of the microchip p laser. Thereby, the non-linear optical element converts the wavelength of the optical output of the microchip laser.

In another embodiment, the non-linear optical element causing the wavelength conversion comprises a wavelength conversion element of quasi-phase matched type. Thereby, the non-linear optical element performs the wavelength conversion operation by using the quasi-phase matching.

In another embodiment, the wavelength conversion element of the quasi-phase matching type is a single element including regions performing the wavelength conversion for the optical output s from the respective microchip lasers.

In another preferred embodiment of the present invention, the microchip laser produces at least two of the three primary color laser beams.

In another preferred embodiment, the solid-state laser medium comprises a material that changes an absorption coefficient or cross section of stimulated emission according to the crystal axes thereof, the solid-state laser materials being the material capable of producing a linearly polarized light as a laser output.

In another preferred embodiment, the solid-state laser medium is disposed with such an orientation that the crystal axis that provides the large optical absorption coefficient coincides with the polarization direction of the pumping light beams from the pumping semiconductor laser array in parallel with the substrate surface of the mounting substrate.

In another preferred embodiment, the pumping laser beams from the pumping semiconductor layer arrays are incident to the solid-state laser medium from two, opposite directions across the solid-state laser medium.

According to the present invention, it becomes possible to provide a low cost and high-output power solid-state laser apparatus pumped by a semiconductor laser such that the solid-state laser apparatus as a compact size suitable for packaging. Further, according to the present invention, the laser apparatus can produce plural wavelengths in the visible wavelength band. Further, the efficiency of laser oscillation is improved.

### BRIEF DESCRIPTION OF THE DRAWINGS

FIG. 1A is a diagram showing the construction of a solid-state laser apparatus according to Embodiment 1, while FIG. 1B shows a solid-state laser medium used in the laser apparatus of FIG. 1A in a front view and further in a side view;

FIG. 2A is a diagram showing the construction of a solid-state laser apparatus according to Embodiment 2, while FIG. 2B shows a solid-state laser medium used in the laser apparatus of FIG. 2A in a front view and further in a side view;

FIG. 3A is a diagram showing the construction of a solid-state laser apparatus according to Embodiment 3, while FIG. 3B shows a solid-state laser medium used in the laser apparatus of FIG. 3A in a front view and further in a side view;

FIG. 4A is a diagram showing the construction of a solid-state laser apparatus according to Embodiment 4, while FIG. 4B shows a solid-state laser medium used in the laser apparatus of FIG. 4A in a front view and further in a side view;

FIG. 5A is a diagram showing the construction of a solid-state laser apparatus according to Embodiment 5, FIG. 5B shows a solid-state laser medium used in the laser apparatus of FIG. 5A in a front view and a side view, while FIG. 5C is a diagram showing the construction of a wavelength conversion element in a front view and side view;

FIG. 6A is a diagram and showing the construction of a solid-state laser apparatus according to Example 6 of the present invention while FIG. 6B shows the solid-state laser apparatus in a side view;

FIGS. 7A and 7B are diagrams respectively showing a front view and a side view of a crystal used for the solid-state laser medium of Example 6;

FIG. 8A is a diagram showing the construction of a solid-state laser apparatus according to Example 7 of the present invention respectively in a front view while FIG. 8B shows the solid-state laser apparatus in a side view;

FIGS. 9A and 9B are diagrams respectively showing a front view and a side view of a crystal used for the solid-state laser medium of Example 7:

FIG. 10A is a diagram showing the construction of a solid-state laser apparatus according to Example 8 of the present invention in a front view while FIG. 10B shows the laser apparatus in a side view;

FIGS. 11A and 11B are diagrams respectively showing a front view and a side view of a crystal used for the solid-state laser medium of Example 8;

FIG. 12A is a diagram showing a solid-sate laser apparatus according to Example 9 while FIG. 12B shows the solid-state laser apparatus in a side view;

FIGS. 13A and 13B are diagrams respectively showing a front view and a side view of a crystal used for the solid-state laser medium in the solid-state laser of Example 9;

FIG. 14 a diagram showing the principle of the Example 2 and Example 4 of the present invention.

### DETAILED DESCRIPTION OF THE INVENTION

Hereinafter, best mode for implementing the present invention will be described with reference to the drawings.

### EXAMPLE 1

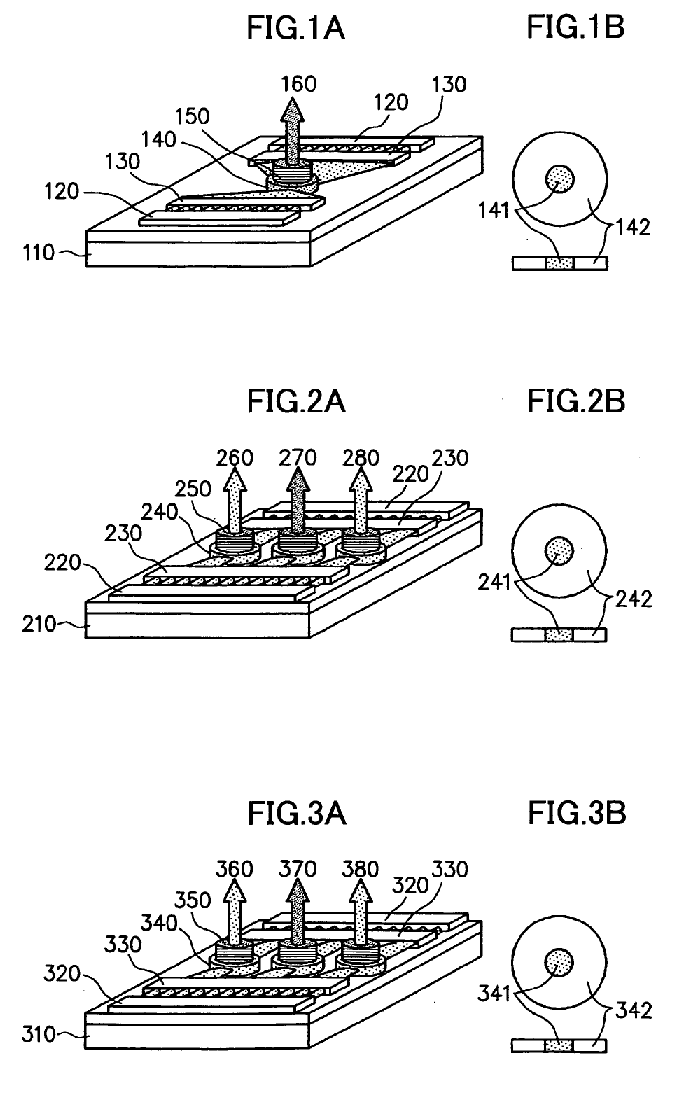

First, Example 1 will be explained with reference to FIGS. 1A and 1B, wherein FIG. 1A is a diagram showing the construction of the solid-state laser of the present example, while FIG. 1B shows the solid-state laser medium used in the solid-state laser of FIG. 1A in a front view and a side view.

Referring to FIG. 1A, the solid-laser apparatus of Example 1 is constructed on a mounting substrate 110 and includes, on the mounting substrate 110, semiconductor laser arrays 120 for pumping, microlens elements 130 cooperating with the respective semiconductor laser arrays 120, a solid-state laser medium 140 and a wavelength conversion element 150.

In the present example, the mounting substrate 110 comprises a flat substrate of aluminum nitride having a size of 50×50 mm and a thickness of 5 mm.

Thereby, it will be noted that there are disposed two semiconductor laser array elements 120, each producing an optical output of 20 W at the wavelength of 808 nm, on the mounting substrate 110 as shown in FIG. 1A.

The microlens 130 focuses the laser beams emitted from the laser diode array 12 to a single point by way of a lens, wherein two such lenses are provided in correspondence to the semiconductor laser arrays as shown in FIG. 1A.

The laser medium 140 comprises a disk-shaped YAG crystal doped with Nd with 1.0 at % (atomic percent), wherein the YAG crystal constituting the laser medium 140 has a thickness of 0.5 mm and a diameter of 3 mm. As shown in FIG. 1B, the YAG crystal 140 is formed of a central region 141 doped with Nd and a surrounding region 142 not doped with Nd, wherein the central region 141 has a diameter of 0.5 mm.

It should be noted that the laser medium 140 is formed by a single crystal of YAG for the entirety thereof and is mounted on a mounting substrate 110 as shown in FIG. 1A.

Each of both end surfaces of the laser medium 140 is provided with a dielectric mirror coating, and thus, there is formed a laser cavity in the laser medium 140. Thereby, the end surface of the medium 140 contacting with the mounting substrate 110 provides high reflectivity at the wavelength of 1064 nm, while the dielectric mirror coating at the opposite end surface provides a transmissivity of about 0.5% at the wavelength of 1064 nm.

With this, the laser medium 140 constitutes a microchip laser including therein a laser cavity such that the microchip laser thus mounted upon the mounting substrate 110 produces a laser output in the direction perpendicular to the principal surface of the mounting substrate 110. Further, the laser medium 140 has a mirror-finished surface at the sidewall surface and an antireflection coating is provided on such a mirror-finished surface so as to reduce the reflection at the wavelength of 808 nm used for the optical pumping. Thereby, pumping laser beams from the semiconductor laser arrays 120 are injected into the laser material 140 with high efficiency.

It should be noted that the wavelength conversion element 150 comprises a LiNbO₃ crystal added with MgO, wherein the wavelength conversion element 150 is formed with polarization reversal with a period of 6.9 μm. With this, the wavelength conversion element 150 satisfies the condition of quasi-phase matching for the wavelength of 1064 nm, and the wavelength conversion element 150 is disposed in the laser output path of the laser medium 140 as shown in FIG. 1A.

It should be noted that the wavelength conversion element 150 is a bulk-type element having a cross-sectional area of 2 mm×2 mm and a length of 10 mm. Thereby, the polarization reversal is formed on the entire cross-sectional area.

Further, a Peltier cooler (not shown) is provided at the bottom side of the mounting substrate 110 for cooling or temperature regulation of the mounting substrate 110.

Next, the operation of Example 1 will be explained.

As shown in FIG. 1A, the laser beams produced by the respective semiconductor laser arrays 120 are caused to pass through respective micro lenses 130 and are incident to the laser medium 140 from two directions.

Thereby, the pumping laser beams thus incident to the laser medium 140 are absorbed by the Nd-doped region 142 at the central part of the laser medium 140, and laser oscillation is caused as the optical radiation formed by the stimulated emission in the laser medium 140 travels back and forth in the laser medium 140 between the end surfaces thereof defining the optical cavity. Thereby, an output laser beam is emitted in the vertical direction to the mounting substrate 110 with the wavelength of 1064 nm.

In the surrounding region 142 of the laser medium 140 not doped with Nd, on the other hand, there occurs no absorption of the pumping light beams, and thus, the laser oscillation occurs only in the central region 141 doped with Nd.

The output laser beam emitted from the laser medium 140 enters into the wavelength conversion element 150 disposed on the output optical path thereof and is converted to second harmonics. With this, a laser beam 160 having the wavelength of 532 nm is obtained.

Thus, with Example 1, a very small laser cavity is realized by using the microchip laser construction for the laser medium 140 and a powerful pumping is realized by using semiconductor laser arrays for the pumping optical source. Further, by pumping the solid-state laser in the direction perpendicular to the direction of the output laser beam, it becomes possible to dissipate the heat generated in the laser medium 140 via the region of the mounting substrate 110 that makes a contact with the laser medium 140. Thereby, the efficiency of heat dissipation is improved and the solid-state laser can provide high output power while having a compact size.

Further, it should be noted that, because the solid-state laser medium and the semiconductor laser array used for the pumping optical source are mounted on the same mounting substrate, it becomes possible to use an automated process for assembling our mounting of the solid-state laser, and it becomes possible to reduce the cost of the solid-state laser apparatus.

Thus, with the present invention as set forth in Example 1, it becomes possible to provide a compact and high-power solid-state laser apparatus suitable for compact packaging with low cost.

More specifically, it becomes possible to reduce the size of the solid-state laser apparatus by mounting the components of the laser apparatus directly on a single mounting substrate such that unnecessary spaces are eliminated. Further, because mounting of the components on the mounting substrate can be achieved similarly as in the case of mounting optical pickups or semiconductor devices, it becomes possible to reduce the cost of the mounting process of the solid-state laser apparatus as compared with the conventional mounting process that relies on a manual work of a human worker.

Further, because the components of the solid-state laser apparatus are mounted on the mounting substrate directly over a wide area, cooling or temperature regulation of these components can be achieved collectively via the mounting substrate, and the efficiency of cooling or temperature regulation is facilitated via the mounting substrate. Thereby, thermal stability of the solid-state laser apparatus is improved.

Further, by realizing the laser cavity structure in the form of microchip that uses edge surfaces of the laser medium for defining the laser cavity, and further by injecting the pumping light beams to the laser medium from the sidewall surface thereof, it becomes possible to achieve size reduction of the laser apparatus by way of size reduction of the laser cavity. Further, it becomes possible to increase the output power of the laser apparatus as a result of increase of the laser pumping power.

Further, by using a composite material for the laser medium 140, it becomes possible to utilize lateral heat transfer from the central laser cavity region also for the dissipation of heat from such a central region. Thereby, thermal stability of the laser apparatus is improved further.

Further, because the laser medium 140 is formed solely of a monocrystalline material, there arises no problem of degradation of laser performance caused by the laser crystal quality, and it becomes possible to secure stable laser oscillation just as in the case where no composite material is used.

Further, by disposing the wavelength conversion element of the quasi-phase matching type in the optical path of the output laser beam outside the laser cavity, the wavelength range of the laser beam is expanded. Further, because of the use of the wavelength conversion element of the quasi-phase matching type, stability of output laser beam after wavelength conversion is also stabilized.

### EXAMPLE 2

Next, Example 2 of the present invention will be described with reference to FIGS. 2A and 2B, wherein FIG. 2A shows the construction of the solid-state laser apparatus of the present embodiment, while FIG. 2B shows the laser medium used with the laser apparatus of FIG. 2A in a front view and a side view.

Referring to Embodiment 2, the laser apparatus is constructed on a mounting substrate 210 and includes a semiconductor laser array 220, microlenses 230, a laser medium 240 and a wavelength conversion element 250, wherein the laser arrays 220, the microlenses 230 and the laser medium 240 are all mounted directly on the mounting substrate 210. The wavelength conversion element 250 is provided on the laser medium 240.

Here, it should be noted that the mounting substrate 210 comprises a flat board of an aluminum nitride having a size of 50×50 mm and a thickness of 5 mm.

On the other hand, the semiconductor laser array 220 produces a pumping laser beam with the wavelength of 808 nm and the output power of 30 W, wherein two such semiconductor laser arrays are disposed on the mounting substrate 210 as represented in FIG. 2A.

Each of the microlens elements 230 uses a lens capable of focusing the laser beam produced by a corresponding semiconductor laser array at three points. As shown in FIG. 2A, two such semiconductor laser elements 220 are provided on the substrate 210.

In the present embodiment, it should be noted that the laser medium 240 comprises a crystal of GdVO₄ doped with Nd with the concentration of 1.0 at %, wherein the GdVO₄ crystal constituting the laser medium 240 takes a form of a disk having a diameter of 3 mm and a thickness of 0.5 mm.

Thereby, it should be noted that the laser medium 240 comprises a central region 241 having a diameter of 0.5 mm and doped with Nd and a surrounding region not doped with Nd. The laser medium 240 is formed as a whole by a monocrystalline material of GdVO₄, and three such GdVO₄ crystals 240 are mounted upon the mounting substrate 210 in correspondence to output laser beams 260, 270 and 270 respectively having the wavelengths 531.5 nm, 456 nm and 673 nm, such that the direction of polarization of the pumping optical beam coincides with the c-axis direction of each GdVO₄ crystal on the mounting substrate 211.

It should be noted that each end surface of the laser medium 240 carries thereon a dielectric mirror coating defining a laser cavity, wherein the laser medium 240 producing the laser output 260 at the wavelength of 1063 nm carries thereon a dielectric mirror coating of large reflectivity at the wavelength of 1063 nm at the side contacting with the mounting substrate 210. Further, the laser medium 240 carries a dielectric mirror coating providing a transmissivity of about 5% at the wavelength of 1063 nm at the opposite end.

On the other hand, the laser medium 240 producing the laser output 270 at the wavelength of 912 nm carries thereon a dielectric mirror coating of large reflectivity at the wavelength of 912 nm at the side contacting with the mounting substrate 210. Further, this laser medium 240 for the wavelength of 912 nm carries a dielectric mirror coating providing a transmissivity of about 5% at the wavelength of 912 nm at the opposite end, wherein this dielectric mirror coating provides a transmissivity of 9909% to the wavelength of 1063 nm.

Further, the laser medium 240 producing the laser output 280 at the wavelength of 808 nm carries thereon a dielectric mirror coating of large reflectivity at the wavelength of 1346 nm at the side contacting with the mounting substrate 210. Further, this laser medium 240 for the wavelength of 808 nm carries a dielectric mirror coating providing a transmissivity of about 5% at the wavelength of 1346 nm at the opposite end, wherein this dielectric mirror coating provides a transmissivity of 99.9% to the wavelength of 1063 nm.

With this, the laser cavities are tuned to the respective laser output wavelengths, and there are formed laser cavities on the mounting substrate 210 such that the respective laser cavities produce the laser outputs 260, 270 and 280 in the direction perpendicular to the mounting substrate 210.

Further, it should be noted that each of the laser media 240 has a mirror finished sidewall surface, and an antireflection coating is provided on such a sidewall surface such that the antireflection coating eliminates reflection at the wavelength of 808 nm. Further, the output laser beams of the semiconductor laser arrays 220 are injected to the respective laser media 240 via the sidewall surfaces thereof.

The wavelength conversion elements 250 are the elements formed of a LiNbO₃ crystal doped with MgO and provided respectively in correspondence to the output laser beams 260, 270 and 280, wherein the wavelength conversion elements 250 for the output laser beams 260, 270 and 280 carry thereon polarization reversal regions formed with the respective pitches of 6.9 μm, 4.2 μm and 12.9 μm.

It should be noted that each of the elements 250 is a device that satisfies the condition of quasi-phase matching to the laser output wavelength corresponding thereto, and the elements 250 are disposed on the optical path of the output laser beams emitted from the respective laser media 240 as represented in FIG. 2A. Thereby, each of the elements 250 has a cross-sectional area of 2 mm×2 mm and a length of 10 mm. Each of the wavelength-conversion elements 250 is a bulk device, and the region of polarization reversal is formed over the entire cross-sectional area in each element 250.

Further, there is provided a Peltier cooling element (not shown) on the underside of the mounting substrate 210 for cooling or temperature regulation of the solid-state laser apparatus via the mounting substrate 210.

Next, the operation of the solid-sate laser apparatus of Example 2 will be explained.

Each of the laser beams emitted from the respective semiconductor laser arrays 220 are injected into each of the three laser media 240 from two directions after passing through the microlens elements 230.

Thereby, the pumping laser beams thus injected into the respective laser media 240 are absorbed by the Nd-doped region 241 at the respective central part of the laser media 240, and there is caused laser oscillation in the optical cavities formed by the end surfaces of the laser media 240. Thereby, the laser beams are emitted from the respective laser media 240 in the direction perpendicular to the principal surface of the mounting substrate 210 with the respective wavelengths of 1063 nm, 912 nm and 1346 nm.

Here, it should be noted that the pumping laser beams from the semiconductor laser arrays 220 are not absorbed by the surrounding region 242 of the laser medium 240 not doped with Nd, and the laser oscillation takes place, in each of the laser media 240, only in the central region 241 doped with Nd.

Thus, the laser beams emitted from the laser media 240 are injected into the respective, corresponding wavelength conversion elements 250 disposed on the optical paths of the output laser beams, and the foregoing output laser beams are converted to the second harmonics. Thereby, laser beams are obtained with the wavelengths of 531.5 nm, 456 nm and 673 nm.

Here, polarization of the pumping laser beam and the orientation of the laser media 240 will be considered with reference to FIG. 14 for the case of Example 2. Because the present section explains only the principles with this regard, the explanation will be given only for the case there is a single solid-state laser medium 240 provided on the mounting substrate 210.

Referring to FIG. 14, the solid-state laser medium 240 of GdVO₄ crystal doped with Nd is disposed on the mounting substrate 210 not illustrated with such an orientation that the c axis of the GdVO₄ crystal providing the maximum optical absorption is coincident to the polarization direction of the pumping laser beam produced by the laser diode array.

With this, the pumping laser beam produced by the semiconductor laser array is absorbed efficiently by the laser medium 240, and the absorbed pumping energy provides energy to the stimulated emission taking place in the solid-state laser medium 240. In the illustrated example, the laser medium 240 is irradiated with the pumping laser beams from two, opposite directions.

The optical radiation thus caused in the laser medium 240 is amplified by stimulated emission as it is reflected back and forth in the medium 240 by a mirror 240M provided at the top edge surface of the laser medium 240 and another mirror not shows on the bottom edge surface of the laser medium 240 and is emitted through the mirror 240M as the output laser beam, wherein the output laser beam thus obtained forms a linearly polarized beam having a polarization direction coincident with the c-axis of the GdVO4 crystal constituting the laser medium 240 in view of the fact that the cross-sectional area of stimulated emission takes the maximum value in the c-axis direction.

By using such a construction that provides a linearly polarized optical output in combination with the wavelength conversion element 250 provided outside the laser cavity, near-ideal efficiency can be attained for the wavelength-conversion by using the so-called SHG device for the wavelength conversion element 250. In order to attain these advantageous features of the present invention, it is important that the orientation of the laser medium 240 is set as indicated in FIG. 14.

In Example 2, it should be noted that a compact laser cavity is realized by using the microchip laser construction for the solid-state laser medium 240 together with high-power pumping by using the semiconductor layer array for the pumping optical source. Further, the efficiency of heat dissipation is improved from region where the laser medium makes a contact with the mounting substrate surface, by setting the direction of the pumping optical beam to be perpendicular to the direction of the output beam of the solid-state laser. Further, by improving the heat resistance of the material of the solid-state laser medium, compact and high-power solid-state laser is realized.

Further, by mounting the solid-state laser medium and the semiconductor laser arrays on the same mounting substrate, assembling and mounting of the laser apparatus can be made by using automated process, and the cost of the laser apparatus can be reduced. Thereby, a compact and high-power solid-state laser apparatus is obtained with low cost.

More specifically, because of the construction in which the components of the laser apparatus are directly mounted on the same mounting substrate, unnecessary space is eliminated and the size of the laser apparatus is reduced. Further, because mounting of the components can be achieved by using the established process of mounting optical pickups or semiconductor devices, the cost of mounting the components of the laser apparatus is reduced as compared with the conventional process in which the components of the laser apparatus have been mounted manually, and it becomes possible to realize a low-cost solid-state laser apparatus.

Further, because the components of the solid-state laser apparatus are mounted directly on the mounting substrate and cooling or temperature regulation is achieved solely via the mounting substrate, the efficiency of cooling of the individual components is improved. Further, the temperature control is made easily by solely controlling the temperate of the mounting substrate. Thereby, an apparatus with high thermal stability is obtained.

Further, by forming the laser cavity to have the microchip laser construction by utilizing the edge surfaces of the solid-state laser medium and by injecting the pumping light beams from the sidewall surface of the laser medium, it becomes possible to construct the laser apparatus to have a compact size by reducing the size of the laser cavity while increasing the output power by increasing the power of the injected pumping light beams.

By using plural such solid-state laser media such that each medium has the microchip construction, and such that the plural laser media have respective, different oscillation wavelengths, it becomes possible to provide a laser apparatus capable of providing laser output with different wavelengths

Further, by using a composite material for the laser medium such that the region of laser oscillation is confined at the central part of the laser medium, it becomes possible to dissipate the heat associated with the laser oscillation also I the lateral direction of the laser medium. Thereby, stability of the laser apparatus to the temperature is improved.

Thus, by utilizing the construction for the solid-state laser medium such that the solid-state laser medium comprises the central core region doped with the necessary impurity element and capable of causing laser oscillation and the surrounding region not doped with the impurity element needed for the laser oscillation, it becomes possible to dissipate the heat generated at the core part of the solid-state laser material with the laser oscillation immediately to the surrounding region. Further, with such a structure, the region of laser oscillation is limited, and it becomes possible to achieve high laser output by improvement of the mode matching efficiency.

By using the same monocrystalline material for the composite solid-state laser medium, it is possible to eliminate the effect of loss caused by the material, similarly to the case of using the construction in which the monocrystalline medium is pumped at the end surface thereof, and it becomes possible to obtain a laser output while suppressing the laser quality.

Further, by using the laser beam from the semiconductor laser array for the optical pumping after dividing the same by using an optical element, it becomes possible to use a common pumping semiconductor laser element for pumping of the respective microchip lasers, without providing a dedicated semiconductor laser element for each of the microchip lasers. Further, by using a pumping semiconductor laser array commonly for all of the microchip lasers, the optical pumping is stabilized and the cost of the components of the laser apparatus is reduced. Thereby, the cost of the laser apparatus is reduced while achieving stabilization of the characteristics at the same time.

Further, by using two pumping semiconductor laser arrays and pumping each of the microchip lasers by the laser beams of the semiconductor laser arrays after dividing by using respective optical elements, the pumping power is increased further, and further increase of output power is realized.

Further, by disposing a non-linear optical element capable of converting the wavelength in the output optical paths of each microchip laser, the output laser beam is subjected to wavelength conversion and it becomes possible to obtain a laser output in the visible wavelength band.

Further, by using a quasi-phase matched wavelength conversion element for the non-linear optical element for the wavelength conversion, it becomes possible to increase the efficiency of wavelength conversion by way of increasing the length of the non-linear optical element. Thereby, the efficiency of the apparatus is improved.

Because two or more of red, green and blue colors are obtained for the output laser beam, the solid-state laser apparatus of the present invention can be applicable to imaging apparatuses that use three primary colors such as image display or printer.

Further, by using GdVO₄ crystal, which is a material that changes the absorption coefficient or cross-sectional area of stimulated emission according to the crystal axes, for the solid-state laser medium capable of providing linearly polarized output, the efficiency of absorption of the pumping light beams is improved together with efficiency of oscillation. Thereby, the overall efficiency of the solid-state laser apparatus is improved.

Further, by coinciding the direction of polarization of the pumping light beams emitted from the pumping semiconductor laser array elements with the direction of the crystal axis in which the absorption coefficient of the solid-state laser material is maximized in the plane parallel to the surface of the mounting substrate, the efficiency of absorption of the pumping light beams is increased, and the efficiency of utilization of the laser output is improved. Thereby, total efficiency of the apparatus is improved.

Further, because the pumping light beams from the pumping semiconductor laser array elements are injected into the solid-state laser medium from two, opposite directions across the solid-state laser medium, more pumping power is injected into the laser medium and more output power is obtained.

### EXAMPLE 3

Next, Example 3 will be explained with reference to FIGS. 3A and 3B, wherein FIG. 3A is a diagram showing the construction of the solid-state laser of the present example, while FIG. 3B shows the solid-state laser medium used in the solid-state laser of FIG. 3A in a front view and a side view.

Referring to FIG. 3A, the solid-laser apparatus of Example 3 is constructed on a mounting substrate 310 and includes, on the mounting substrate 310, semiconductor laser arrays 320 for pumping, microlens elements 330 cooperating with the respective semiconductor laser arrays 320, a solid-state laser medium 340 and a wavelength conversion element 350.

In the present example, the mounting substrate 310 comprises a flat substrate of aluminum nitride having a size of 50×50 mm and a thickness of 5 mm.

Thereby, it will be noted that there are disposed two semiconductor laser array elements 320, each producing an optical output of 30 W at the wavelength of 808 nm, on the mounting substrate 310 as shown in FIG. 3A.

The microlens element 330 uses a lens focusing the laser beams emitted from the semiconductor laser array 320 at three points and two such microlens elements 330 are provided in correspondence to the two semiconductor laser arrays 320 as shown in FIG. 3A.

The laser medium 340 comprises a disk-shaped YAG ceramic doped with Nd with 3.0 at % (atomic percent), wherein the YAG ceramic constituting the laser medium 340 has a thickness of 0.5 mm and a diameter of 3 mm. As shown in FIG. 3B, the YAG ceramic 340 is formed of a central region 341 doped with Nd and a surrounding region 342 not doped with Nd, wherein the central region 341 has a diameter of 0.5 mm. Thus, the laser medium 340 is formed of ceramic for the entirety thereof.

As shown in FIG. 3A, three such solid-state laser media 340 are mounted on the mounting substrate 310 such that the one provides a laser output 360 at the wavelength of 532 nm, the one provides a laser output 370 at the wavelength of 473 nm and the one provides a laser output 380 at the wavelength of 660 nm.

Each of both end surfaces of the laser medium 340 is provided with a dielectric mirror coating, and thus, there is formed a laser cavity in the laser medium 340. Thereby, the medium 340 producing the laser output 360 provides high reflectivity at the wavelength of 1064 nm at the end surface thereof contacting with the mounting substrate 310, while the dielectric mirror coating at the opposite end surface provides a transmissivity of about 0.5% at the wavelength of 1064 nm.

Further, the medium 340 that produces the laser output 370 provides high reflectivity at the wavelength of 946 nm at the end surface thereof contacting with the mounting substrate 310, while the dielectric mirror coating at the opposite end surface provides a transmissivity of about 0.5% at the wavelength of 946 nm and transmissivity of 99.9% at the wavelength of 1064 nm.

Further, the medium 340 that produces the laser output 380 provides high reflectivity at the wavelength of 1320 nm at the end surface thereof contacting with the mounting substrate 310, while the dielectric mirror coating at the opposite end surface provides a transmissivity of about 0.5% at the wavelength of 1320 nm and transmissivity of 99.9% at the wavelength of 1064 nm.

With this, the respective laser media 340 constitute a laser cavity for corresponding laser output wavelengths and produce a laser output in the direction perpendicular to the principal surface of the mounting substrate 310. Further, each of the laser media 340 has a mirror-finished surface at the sidewall surface and an antireflection coating is provided on such a mirror-finished surface so as to reduce the reflection at the wavelength of 808 nm used for the optical pumping. Thereby, pumping laser beams from the semiconductor laser arrays 320 are injected into the laser medium 340 with high efficiency.

The wavelength conversion elements 350 are the elements formed of a LiNbO₃ crystal doped with MgO and provided respectively in correspondence to the output laser beams 360, 370 and 380, wherein the wavelength conversion elements 350 for the output laser beams 360, 370 and 380 carry thereon polarization reversal regions formed with respective pitches of 6.9 μm, 4.2 μm and 12.9 μm.

It should be noted that each of the elements 350 is a device that satisfies the condition of quasi-phase matching to the laser output wavelength corresponding thereto, and the elements 350 are disposed on the optical path of the output laser beams emitted from the respective laser media 340 as represented in FIG. 3A. Thereby, each of the elements 250 has a cross-sectional area of 2 mm×2 mm and a length of 10 mm. Each of the wavelength-conversion elements 350 is a bulk device, and the region of polarization reversal is formed over the entire cross-sectional area in each element 350.

Further, there is provided a Peltier cooling element (not shown) on the underside of the mounting substrate 310 for cooling or temperature regulation of the solid-state laser apparatus via the mounting substrate 310.

Next, the operation of the solid-sate laser apparatus of Example 3 will be explained.

Each of the laser beams emitted from the respective semiconductor laser arrays 320 are injected into each of the three laser media 340 from two directions after passing through the microlens elements 330.

Thereby, the pumping laser beams thus injected into the respective laser media 340 are absorbed by the Nd-doped region 341 at the respective central part of the laser media 340, and there is caused laser oscillation in the optical cavities formed by the end surfaces of the laser media 340. Thereby, the laser beams are emitted from the respective laser media 340 in the direction perpendicular to the principal surface of the mounting substrate 310 with the respective wavelengths of 1063 nm, 912 nm and 1346 nm.

Here, it should be noted that the pumping laser beams from the semiconductor laser arrays 320 are not absorbed by the surrounding region 342 of the laser medium 340 not doped with Nd, and the laser oscillation takes place, in each of the laser media 340, only in the central region 341 doped with Nd.

Thus, the laser beams emitted from the laser media 340 are injected into the respective, corresponding wavelength conversion elements 350 disposed on the optical paths of the output laser beams, and the foregoing output laser beams are converted to the second harmonics. Thereby, laser beams are obtained with the wavelengths of 531.5 nm, 456 nm and 673 nm.

In Example 3, the laser cavity is made compact by using the microchip construction for the solid-state laser material and high power pumping is realized by using the semiconductor laser array for the pumping optical sources. Further, efficiency of heat dissipation from the region of the laser medium contacting with the mounting substrate is facilitated by setting the direction of the optical pumping of the solid-state laser material to be perpendicular to the laser output direction. Further, by improving the heat resistance of the solid-state laser medium, a compact and high-output power construction is realized for the solid-state laser.

Further, it should be noted that, because the solid-state laser medium and the semiconductor laser array used for the pumping optical source are mounted on the same mounting substrate, it becomes possible to use an automated process for assembling our mounting of the solid-state laser, and it becomes possible to reduce the cost of the solid-state laser apparatus.

Thus, with the present invention as set forth in Example 3, it becomes possible to provide a compact and high-power solid-state laser apparatus suitable for packaging with low cost.

More specifically, it becomes possible to reduce the size of the solid-state laser apparatus by mounting the components of the laser apparatus directly on a single mounting substrate such that unnecessary spaces are eliminated. Further, because mounting of the components on the mounting substrate can be achieved similarly as in the case of mounting optical pickups or semiconductor devices, it becomes possible to reduce the cost of the mounting process of the solid-state laser apparatus as compared with the conventional mounting process that relies on a manual work of a human worker.

Further, because the components of the solid-state laser apparatus are mounted on the mounting substrate directly over a wide area, cooling or temperature regulation of these components can be achieved collectively via the mounting substrate, and the efficiency of cooling or temperature regulation is facilitated via the mounting substrate. Thereby, thermal stability of the solid-state laser apparatus is improved.

Further, by realizing the laser cavity structure in the form of microchip that uses edge surfaces of the laser medium for defining the laser cavity, and further by injecting the pumping light beams to the laser medium from the sidewall surface thereof, it becomes possible to achieve size reduction of the laser apparatus by way of size reduction of the laser cavity. Further, it becomes possible to increase the output power of the laser apparatus as a result of increase of the laser pumping power.

By using plural such solid-state laser media such that each medium has the microchip construction, and such that the plural laser media have respective, different oscillation wavelengths, it becomes possible to provide a laser apparatus capable of providing laser output with different wavelengths

Further, by utilizing the construction for the solid-state laser medium such that the solid-state laser medium comprises the central core region doped with the necessary impurity element and capable of causing laser oscillation and the surrounding region not doped with the impurity element needed for the laser oscillation, it becomes possible to dissipate the heat generated at the core part of the solid-state laser material with the laser oscillation immediately to the surrounding region. Further, with such a structure, the region of laser oscillation is limited, and it becomes possible to achieve high laser output by improvement of the mode matching efficiency.

By using a ceramic material of the same composition for the composite solid-state laser medium, it becomes possible to mass produce the solid-state laser medium, and with this, it becomes possible to obtain the solid-state laser media of uniform characteristics with low cost. Thereby, device-to-device variation of the laser output is reduced while reducing the cost of the material for the laser medium.

Further, by using the laser beam from the semiconductor laser array for the optical pumping after dividing the same by using an optical element, it becomes possible to use a common pumping semiconductor laser element for pumping of the respective microchip lasers, without providing a dedicated semiconductor laser element for each of the microchip lasers. Further, by using a pumping semiconductor laser array commonly for all of the microchip lasers, the optical pumping is stabilized and the cost of the components of the laser apparatus is reduced. Thereby, the cost of the laser apparatus is reduced while achieving stabilization of the characteristics at the same time.

Further, by using two pumping semiconductor laser arrays and pumping each of the microchip lasers by the laser beams of the semiconductor laser arrays after dividing by using respective optical elements, the pumping power is increased further, and further increase of output power is realized.

Further, by disposing a non-linear optical element capable of converting the wavelength in the output optical paths of each microchip laser, the output laser beam is subjected to wavelength conversion and it becomes possible to obtain a laser output in the visible wavelength band.

Further, by using a quasi-phase matched wavelength conversion element for the non-linear optical element for the wavelength conversion, it becomes possible to increase the efficiency of wavelength conversion by way of increasing the length of the non-linear optical element. Thereby, the efficiency of the apparatus is improved.

Because two or more of red, green and blue colors are obtained for the output laser beam, the solid-state laser apparatus of the present invention can be applicable to imaging apparatuses that use three primary colors such as image display or printer.

### EXAMPLE 4

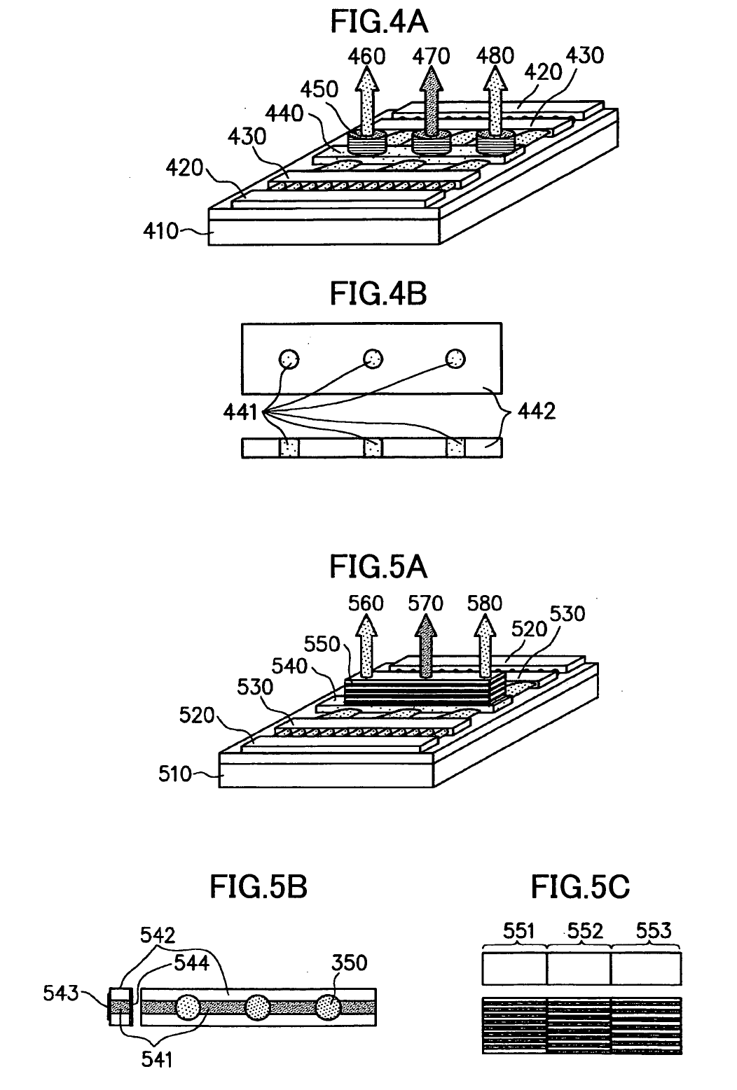

Next, Example 4 will be explained with reference to FIGS. 4A and 4B, wherein FIG. 4A is a diagram showing the construction of the solid-state laser of the present example, while FIG. 4B shows the solid-state laser medium used in the solid-state laser of FIG. 4A in a front view and a side view.

Referring to FIG. 4A, the solid-laser apparatus of Example 4 is constructed on a mounting substrate 410 and includes, on the mounting substrate 410, semiconductor laser arrays 420 for pumping, microlens elements 430 cooperating with the respective semiconductor laser arrays 420, a solid-state laser medium 440 and a wavelength conversion element 450.

In the present example, the mounting substrate 410 comprises a flat substrate of aluminum nitride having a size of 50×50 mm and a thickness of 5 mm.

Thereby, it will be noted that there are disposed two semiconductor laser array elements 420, each producing an optical output of 30 W at the wavelength of 808 nm, on the mounting substrate 410 as shown in FIG. 4A.

The microlens element 430 uses a lens focusing the laser beams emitted from the semiconductor laser array 420 at three points and two such microlens elements 430 are provided in correspondence to the two semiconductor laser arrays 420 as shown in FIG. 4A.

The laser medium 440 comprises a disk-shaped crystal having a thickness of 0.5 mm and a size of 3 mm×9 mm and has a construction shown in FIG. 4B in which it will be noted that there is provided a disk-shaped central region 411 formed a GdVO₄ monocrystal doped with Nd with 1.0 at % (atomic percent), wherein the central region 441 is a surrounded by a region 442 of an optically transparent YAG ceramic not doped with Nd. Thereby, the GdVO₄ monocrystal 411 is deposed on the mounting substrate 410 with an orientation such that the c-axis thereof coincides with the polarization direction of the pumping light beams from the semiconductor laser arrays 420.

Thereby, the solid-state laser medium 440 carries dielectric coatings at both end surfaces thereof so as to form a laser cavity, and three such regions 411 are formed on the laser medium 440 in such a manner that the one provides a laser output 460 at the wavelength of 531.5 nm, the one provides a laser output 470 at the wavelength of 456 nm and the one provides a laser output 480 at the wavelength of 673 nm.

Thereby, in the region producing the laser output 460 (531.5 nm), the medium 340 carries a dielectric coating of high reflectivity for the wavelength of 1063 nm at the end surface contacting with the mounting substrate 410 and a dielectric coating providing the transmissivity of about 5% to the wavelength of 1063 nm at the opposite end surface.

Similarly, in the region producing the laser output 470 (456 nm), the medium 340 carries a dielectric coating of high reflectivity for the wavelength of 912 nm at the end surface contacting with the mounting substrate 410 and a dielectric coating providing the transmissivity of about 5% to the wavelength of 912 nm and the transmissivity of 99.9% for the wavelength of 1063 nm at the opposite end surface.

Further, in the region producing the laser output 480 (673 nm), the medium 340 carries a dielectric coating of high reflectivity for the wavelength of 1346 nm at the end surface contacting with the mounting substrate 410 and a dielectric coating providing the transmissivity of about 5% to the wavelength of 1346 nm and the transmissivity of 99.9% for the wavelength of 1063 nm at the opposite end surface.

With this, there are formed laser cavities in corresponding to the respective laser output wavelengths, and laser output is obtained in the direction perpendicular to the principal surface of the mounting substrate 410. Further, the laser medium 440 has a mirror-finished surface at the sidewall surface and an antireflection coating is provided on such a mirror-finished surface so as to reduce the reflection at the wavelength of 808 nm used for the optical pumping. Thereby, pumping laser beams from the semiconductor laser arrays 420 are injected into the laser medium 440 with high efficiency.

The wavelength conversion elements 450 are the elements formed of a LiNbO₃ crystal doped with MgO and provided respectively in correspondence to the output laser beams 460, 470 and 480, wherein the wavelength conversion elements 450 for the output laser beams 460, 470 and 480 carry thereon polarization reversal regions formed with the respective pitches of 6.9 μm, 4.2 μm and 12.9 μm.

It should be noted that each of the elements 450 is a device that satisfies the condition of quasi-phase matching to the laser output wavelength corresponding thereto, and the elements 450 are disposed on the optical path of the output laser beams emitted from the respective laser media 440 as represented in FIG. 4A. Thereby, each of the elements 450 has a cross-sectional area of 2 mm×2 mm and a length of 10 mm. Each of the wavelength-conversion elements 450 is a bulk device, and the region of polarization reversal is formed over the entire cross-sectional area in each element 450.

Further, there is provided a Peltier cooling element (not shown) on the underside of the mounting substrate 410 for cooling or temperature regulation of the solid-state laser apparatus via the mounting substrate 410.

Next, the operation of the solid-sate laser apparatus of Example 4 will be explained.

Each of the laser beams emitted from the respective semiconductor laser arrays 420 is injected into the laser medium 440 from two directions after passing through the microlens elements 430.

Thereby, the pumping laser beams thus injected into the respective laser medium 440 are absorbed by the three Nd-doped monocrystalline regions 441 formed inside the laser medium 440, and there is caused laser oscillation in the respective laser cavities formed by the end surfaces of the laser medium 440. Thereby, the laser beams are emitted from the respective laser media 441 in the direction perpendicular to the principal surface of the mounting substrate 410 with the respective wavelengths of 1063 nm, 912 nm and 1346 nm.

Here, it should be noted that the pumping laser beams from the semiconductor laser arrays 420 are not absorbed by the surrounding ceramic region 442 of the laser medium 440 not doped with Nd, and the laser oscillation takes place only in the Nd-doped regions 441.

Thus, the laser beams emitted from the laser media 441 are injected into the respective, corresponding wavelength conversion elements 450 disposed on the optical paths of the output laser beams, and the foregoing output laser beams are converted to the second harmonics. Thereby, laser beams are obtained with the wavelengths of 531.5 nm, 456 nm and 673 nm.

Here, polarization of the pumping laser beam and the orientation of the laser media 441 will be considered with reference to FIG. 14 for the case of Example 4. Because the present section explains only the principles with this regard, the explanation will be given only for the case there is a single solid-state laser medium 240 provided on the mounting substrate 410.

Referring to FIG. 14, the solid-state laser medium of GdVO₄ crystal doped with Nd is disposed on the mounting substrate 410 not illustrated with such an orientation that the c axis of the GdVO₄ crystal 441 providing the maximum optical absorption is coincident to the polarization direction of the pumping laser beam produced by the laser diode array.

With this, the pumping laser beam produced by the semiconductor laser array is absorbed efficiently by the laser medium 441, and the absorbed pumping energy provides energy to the stimulated emission taking place in the solid-state laser medium 441. In the illustrated example, the laser medium 441 is irradiated with the pumping laser beams from two, opposite directions.

The optical radiation thus caused in the laser medium 441 is amplified by stimulated emission as it is reflected back and forth in the medium 441 by a mirror 240M provided at the top edge surface of the laser medium 441 and another mirror not shows on the bottom edge surface of the laser medium 441 and is emitted through the mirror 440M as the output laser beam, wherein the output laser beam thus obtained forms a linearly polarized beam having a polarization direction coincident with the c-axis of the GdVO₄ crystal constituting the laser medium 440 in view of the fact that the cross-sectional area of stimulated emission takes the maximum value in the c-axis direction.

By using such a construction that provides a linearly polarized optical output in combination with the wavelength conversion element 450 provided outside the laser cavity, near-ideal efficiency can be attained for the wavelength-conversion by using the so-called SHG device for the wavelength conversion element 450. In order to attain these advantageous features of the present invention, it is important that the orientation of the laser medium 240 is set as indicated in FIG. 14.

In Example 4, it should be noted that a compact laser cavity is realized by using the microchip construction for the solid-state laser medium together with high-power pumping by using the semiconductor layer array for the pumping optical source. Further, the efficiency of heat dissipation is improved from region where the laser medium makes a contact with the mounting substrate surface, by setting the direction of the pumping optical beam to be perpendicular to the direction of the output beam of the solid-state laser. Further, by improving the heat resistance of the material of the solid-state laser medium, compact and high-power solid-state laser is realized.

Further, by mounting the solid-state laser medium and the semiconductor laser arrays on the same mounting substrate, assembling and mounting of the laser apparatus can be made by using automated process, and the cost of the laser apparatus can be reduced. Thereby, a compact and high-power solid-state laser apparatus is obtained with low cost.

Further, by forming plural microchip lasers within a single solid-state laser medium with respective, different wavelengths, it becomes possible to reduce the number of components while at the same time realizing plural wavelengths, and it becomes possible to reduce the cost of the materials used for the laser apparatus. Further, the number of steps for assembling the laser apparatus is reduced. Thereby, the cost of the laser apparatus is reduced.

Further, by utilizing the construction for the solid-state laser medium such that the solid-state laser medium comprises the central core region doped with the necessary impurity element and capable of causing laser oscillation and the surrounding region not doped with the impurity element needed for the laser oscillation, it becomes possible to dissipate the heat generated at the core part of the solid-state laser material with the laser oscillation immediately to the surrounding region. Further, with such a structure, the region of laser oscillation is limited, and it becomes possible to achieve high laser output by improvement of the mode matching efficiency.

Further, by constructing the composite solid-state laser medium such that the region doped with the impurity needed for laser oscillation and thus capable of causing laser oscillation comprises a monocrystalline material and the region not doped with the impurity needed for laser oscillation comprises a ceramic material, the problem of degradation of laser quality is successfully avoided as a result of use of the monocrystalline material for the region that causes the laser oscillation. On the other hand, the cost of the laser medium is reduced by using the ceramic material for the region not causing laser oscillation. Thus, the present embodiment can achieve high laser quality and low cost at the same time.

Further, by using the laser beam from the semiconductor laser array for the optical pumping after dividing the same by using an optical element, it becomes possible to use a common pumping semiconductor laser element for pumping of the respective microchip lasers, without providing a dedicated semiconductor laser element for each of the microchip lasers. Further, by using a pumping semiconductor laser array commonly for all of the microchip lasers, the optical pumping is stabilized and the cost of the components of the laser apparatus is reduced. Thereby, the cost of the laser apparatus is reduced while achieving stabilization of the characteristics at the same time.

Further, by using two pumping semiconductor laser arrays and pumping each of the microchip lasers by the laser beams of the semiconductor laser arrays after dividing by using respective optical elements, the pumping power is increased further, and further increase of output power is realized.

Further, by disposing a non-linear optical element capable of converting the wavelength in the output optical paths of each microchip laser, the output laser beam is subjected to wavelength conversion and it becomes possible to obtain a laser output in the visible wavelength band.

Further, by using a quasi-phase matched wavelength conversion element for the non-linear optical element for the wavelength conversion, it becomes possible to increase the efficiency of wavelength conversion by way of increasing the length of the non-linear optical element. Thereby, the efficiency of the apparatus is improved.

Because two or more of red, green and blue colors are obtained for the output laser beam, the solid-state laser apparatus of the present invention can be applicable to imaging apparatuses that use three primary colors such as image display or printer.

Further, by using GdVO₄ crystal, which is a material that changes the absorption coefficient or cross-sectional area of stimulated emission according to the crystal axes, for the solid-state laser medium capable of providing linearly polarized output, the efficiency of absorption of the pumping light beams is improved together with efficiency of oscillation. Thereby, the overall efficiency of the solid-state laser apparatus is improved.

Further, by coinciding the direction of polarization of the pumping light beams emitted from the pumping semiconductor laser array elements with the direction of the crystal axis in which the absorption coefficient of the solid-state laser material is maximized in the plane parallel to the surface of the mounting substrate, the efficiency of absorption of the pumping light beams is increased, and the efficiency of utilization of the laser output is improved. Thereby, total efficiency of the apparatus is improved.

Further, because the pumping light beams from the pumping semiconductor laser array elements are injected into the solid-state laser medium from two, opposite directions across the solid-state laser medium, more pumping power is injected into the laser medium and more output power is obtained.

### EXAMPLE 5

Next, Example 5 will be explained with reference to FIGS. 5A-5C, wherein FIG. 5A is a diagram showing the construction of the solid-state laser of the present example, FIG. 5B shows the solid-state laser medium used in the solid-state laser of FIG. 5A in a front view and a side view, while FIG. 5C shows the construction of the wavelength conversion element in a front view and a side view.

Referring to FIG. 5A, the solid-laser apparatus of Example 5 is constructed on a mounting substrate 510 and includes, on the mounting substrate 510, semiconductor laser arrays 520 for pumping, microlens elements 530 cooperating with the respective semiconductor laser arrays 520, a solid-state laser medium 540 and a wavelength conversion element 550.

In the present example, the mounting substrate 510 comprises a flat substrate of aluminum nitride having a size of 50×50 mm and a thickness of 5 mm.

Thereby, it will be noted that there are disposed two semiconductor laser array elements 520, each producing an optical output of 30 W at the wavelength of 808 nm, on the mounting substrate 510 as shown in FIG. 5A.

The microlens element 530 uses a lens focusing the laser beams emitted from the semiconductor laser array 520 at three points and two such microlens elements 530 are provided in correspondence to the two semiconductor laser arrays 520 as shown in FIG. 4A.

The laser medium 540 has a construction shown in FIG. 5B, in which it will be noted that a transparent sapphire plate 542 mounted upon the mounting substrate constitutes the laser medium 540, and a band 541 of a YAG ceramic doped with Nd with 3.0 at % is formed in the sapphire plate 542 with the width of 0.5 mm.

The laser medium 540 is provided with a dielectric cavity coating at both end surfaces thereof such that, in the region corresponding to a laser output 560 (532 nm), the surface contacting with the mounting substrate 510 is provided a coating of high reflectivity for the wavelength of 1064 nm, while the opposite end is provided with a coating that provides a transmissivity of about 5% to the wavelength of 1064 nm.

Further, in the region corresponding to a laser output 570 (463 nm), the surface of the laser medium 540 contacting with the mounting substrate 510 is provided with a coating of high reflectivity for the wavelength of 946 nm, while the opposite end is provided with a coating that provides a transmissivity of about 5% to the wavelength of 946 nm and the transmissivity of 99.9% for the wavelength of 1064 nm.

Further, in the region corresponding to a laser output 580 (660 nm), the surface of the laser medium 540 contacting with the mounting substrate 510 is provided with a coating of high reflectivity for the wavelength of 1320 nm, while the opposite end is provided with a coating that provides a transmissivity of about 5% to the wavelength of 1320 nm and the transmissivity of 99.9% for the wavelength of 1064 nm.

With this, laser cavities are formed in correspondence to respective laser output wavelengths, and the laser beams are emitted in the direction perpendicular to the mounting substrate 510. Further, the laser medium 540 has a mirror finished sidewall covered with an antireflection coating to the wavelength of 808 nm, and the pumping laser beams of the semiconductor laser arrays 520 are incident to the laser medium 540 form the lateral direction.

The wavelength conversion element 550 is an element formed of a LiNbO₃ crystal doped with MgO and provided with regions 551, 552 and 553 respectively in correspondence to the output laser beams 560, 570 and 580 as shown in FIG. 5C, wherein the region 551, 552 and 553 are respectively formed with polarization reversal regions formed with the pitches of 6.9 μm, 4.2 μm and 12.9 μm.

It should be noted that the element 550 is a device that satisfies the condition of quasi-phase matching to the respective laser output wavelengths, and the element 550 is disposed on the optical path of the output laser beams emitted from the laser medium 540 as represented in FIG. 5A. Thereby, the element 550 has a cross-sectional area of 2 mm×2 mm and a length of 10 mm. Each of the wavelength-conversion elements 450 is a bulk device, and the region of polarization reversal is formed over the entire cross-sectional area in each element 450.

Further, there is provided a Peltier cooling element (not shown) on the underside of the mounting substrate 510 for cooling or temperature regulation of the solid-state laser apparatus via the mounting substrate 510.

Next, the operation of the solid-sate laser apparatus of Example 5 will be explained.

Each of the laser beams emitted from the respective semiconductor laser arrays 520 is injected into the laser medium 540 from two directions after passing through the microlens elements 530.

Thereby, the pumping laser beams thus injected into the respective laser medium 540 are absorbed by the Nd-doped monocrystalline region 541 formed inside the laser medium 540, and there is caused laser oscillation in the respective laser cavities formed by the end surfaces of the laser medium 540. Thereby, the laser beams are emitted from the laser medium 541 in the direction perpendicular to the principal surface of the mounting substrate 510 with the wavelengths of 1063 nm, 912 nm and 1346 nm.

Here, it should be noted that the pumping laser beams from the semiconductor laser arrays 520 are not absorbed by the surrounding ceramic region 542 of the laser medium 540 not doped with Nd, and the laser oscillation takes place only in the Nd-doped region 541.

Thus, the laser beams emitted from the laser medium 541 are injected into the wavelength conversion element 550 disposed on the optical paths of the output laser beams, and the foregoing output laser beams are converted to the second harmonics and the laser beams of wavelengths of 531.5 nm, 456 nm and 673 nm are obtained.

In Example 5, it should be noted that a compact laser cavity is realized by using the microchip construction for the solid-state laser medium together with high-power pumping by using the semiconductor layer array for the pumping optical source. Further, the efficiency of heat dissipation is improved from region where the laser medium makes a contact with the mounting substrate surface, by setting the direction of the pumping optical beam to be perpendicular to the direction of the output beam of the solid-state laser. Further, by improving the heat resistance of the material of the solid-state laser medium, compact and high-power solid-state laser is realized.

Further, by mounting the solid-state laser medium and the semiconductor laser arrays on the same mounting substrate, assembling and mounting of the laser apparatus can be made by using automated process, and the cost of the laser apparatus can be reduced. Thereby, a compact and high-power solid-state laser apparatus is obtained with low cost.

Further, by forming plural microchip lasers within a single solid-state laser medium with respective, different wavelengths, it becomes possible to reduce the number of components while at the same time realizing plural wavelengths, and it becomes possible to reduce the cost of the materials used for the laser apparatus. Further, the number of steps for assembling the laser apparatus is reduced. Thereby, the cost of the laser apparatus is reduced.

Further, by utilizing the construction for the solid-state laser medium such that the solid-state laser medium comprises the central core region doped with the necessary impurity element and capable of causing laser oscillation and the surrounding region not doped with the impurity element needed for the laser oscillation, it becomes possible to dissipate the heat generated at the core part of the solid-state laser material with the laser oscillation immediately to the surrounding region. Further, with such a structure, the region of laser oscillation is limited, and it becomes possible to achieve high laser output by improvement of the mode matching efficiency.

Further, by constructing the composite solid-state laser medium such that the region doped with the impurity needed for laser oscillation and thus capable of causing laser oscillation comprises a monocrystalline material and the region not doped with the impurity needed for laser oscillation comprises a ceramic material, the problem of degradation of laser quality is successfully avoided as a result of use of the monocrystalline material for the region that causes the laser oscillation. On the other hand, the cost of the laser medium is reduced by using the ceramic material for the region not causing laser oscillation. Thus, the present embodiment can achieve high laser quality and low cost at the same time.

Further, by using the laser beam from the semiconductor laser array for the optical pumping after dividing the same by using an optical element, it becomes possible to use a common pumping semiconductor laser element for pumping of the respective microchip lasers, without providing a dedicated semiconductor laser element for each of the microchip lasers. Further, by using a pumping semiconductor laser array commonly for all of the microchip lasers, the optical pumping is stabilized and the cost of the components of the laser apparatus is reduced. Thereby, the cost of the laser apparatus is reduced while achieving stabilization of the characteristics at the same time.

Further, by using two pumping semiconductor laser arrays and pumping each of the microchip lasers by the laser beams of the semiconductor laser arrays after dividing by using respective optical elements, the pumping power is increased further, and further increase of output power is realized.

Further, by disposing a non-linear optical element capable of converting the wavelength in the output optical paths of each microchip laser, the output laser beam is subjected to wavelength conversion and it becomes possible to obtain a laser output in the visible wavelength band.

Further, by using a quasi-phase matched wavelength conversion element for the non-linear optical element for the wavelength conversion, it becomes possible to increase the efficiency of wavelength conversion by way of increasing the length of the non-linear optical element. Thereby, the efficiency of the apparatus is improved.

Because the wavelength conversion element of the quasi-phase matching type is a single device having plural regions for wavelength conversion of plural output laser beams of the microchip lasers, and thus, only one wavelength conversion element is sufficient for causing the desired wavelength conversion for the output laser beams. Thereby, the cost for the wavelength conversion element is reduced together with the number of the parts. Further, the assembling process of the laser apparatus is simplified and the cost of the laser apparatus is reduced.

Because two or more of red, green and blue colors are obtained for the output laser beam, the solid-state laser apparatus of the present invention can be applicable to imaging apparatuses that use three primary colors such as image display or printer.

### EXAMPLE 6

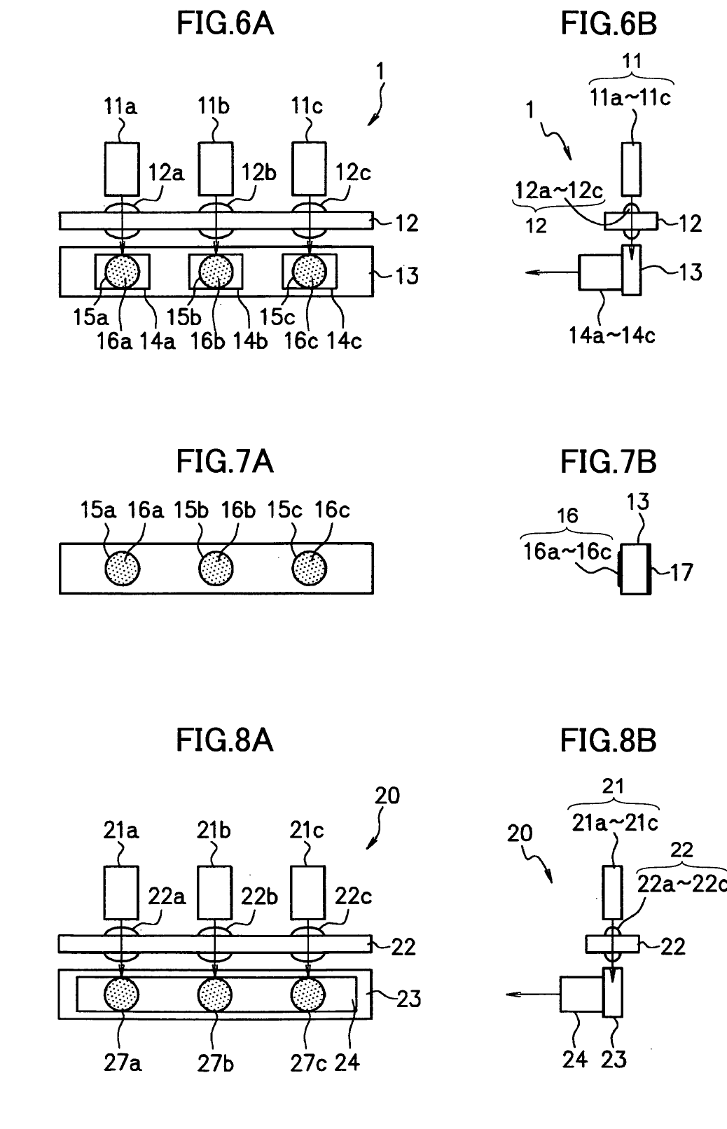

Next, Example 6 will be explained with reference to FIGS. 6A-6B and 7A-7B, wherein the laser apparatus of the present embodiment is used for a multiple-wavelength laser optical source and FIG. 6A shows the solid-state laser apparatus of the present embodiment in a front view while FIG. 6B shows the same laser apparatus in a side view. Further, FIGS. 7A and 7B show the solid-state laser medium used in the solid-state laser of FIG. 6A respectively in a front view and a side view.

Referring to the drawings, a solid-state laser apparatus 1 of the present embodiment comprises three semiconductor laser elements 11a-11c, a microlens array 12 including microlenses 12a-12c in correspondence to the laser elements 11a-11c, a single solid-state laser crystal (solid-state layer medium) 13 and a non-linear optical crystal (non-linear optical element or wavelength conversion element) 14. Further, three cavities 15a-15c of different oscillation wavelength conditions are provided on the foregoing single solid-state laser crystal 13.

Here, each of the semiconductor laser elements 11a-11c comprises a laser diode that causes single-mode laser oscillation at the wavelength of 808 nm with the maximum power of about 2 W. On the other hand, the microlens array 12 is formed of a quartz glass and focuses the laser beams of the laser elements 11a-11c such that the beam waists thereof are located generally at the center of the laser cavities 15a-15c, respectively.

For the solid-state laser crystal 13, a YAG crystal doped with Nd is used. In the present example, the Nd concentration is set to 1.0 at %. The solid-state laser crystal 13 may have a size of 3 mm in the width, 10 mm in the length and 0.8 mm in the thickness. The sidewall surfaces and end surfaces of the crystal 13 are subjected to optical degree polishing.

On the front and rear surfaces of the solid-state laser crystal 13, there are provided dielectric surface coatings 16 and 17 as shown in FIGS. 7A and 7B, wherein the coating 17 at the rear surface of the solid-state laser crystal 13 is formed on the entire surface thereof so as to provide high reflectivity (99.9% or higher) at the wavelengths of the Nd:YAG crystal of 1319 nm, 1064 nm and 946 nm.

On the other hand, with regard to the surface coating 16 of the solid-state laser crystal 13, there are formed three circular coating areas 16a-16c as shown in FIG. 7A, and in correspondence to these, there are formed three laser cavities 15a-15c with different oscillation wavelength conditions.

Here, it should be noted that the coating 16a at the front side of the solid-state laser crystal 13 is tuned to the laser oscillation at the wavelength of 1319 nm (reflectivity of about 98% for the wavelength of 1319 nm and transmissivity of about 100% for the wavelengths of 1064 nm and 946 nm). On the other hand, the coating 16b at the front side of the solid-state laser crystal 13 is tuned to the laser oscillation at the wavelength of 1064 nm (reflectivity of about 98% for the wavelength of 1064 nm; transmissivity of about 100% for the wavelengths of 1319 nm and 946 nm), and the coating 16c at the front side of the solid-state laser crystal 13 is tuned to the laser oscillation at the wavelength of 946 nm (reflectivity of about 98% for the wavelength of 946 nm; transmissivity of about 100% for the wavelengths of 1319 nm and 1064 nm).

Further, there are provided three non-linear optical crystals 14a-14c, wherein each of the crystals 14a-14c comprises a Mg:LiNbO₃ crystal formed with a periodic polarization reversal structure. In the example, the crystals 14a-14c has an aperture of 2 mm×3 mm and a thickness of 2 mm. The periodic reversal polarization is formed in the direction perpendicular to the output direction of the laser beam. In order to obtain the second harmonic (SHG) output for each of the laser outputs of the respective laser cavities 15a-15c, the period of polarization reversal is set to 12.9 μm for the output wavelength of 1319 nm, 7.0 μm for the output wavelength of 1064 nm and 4.8 μm for the output wavelength of 946 nm. Thereby, the LiNbO₃ crystals 14a-14c are disposed outside the cavities 15a-15c on the optical path of the exiting laser beams.

In operation, the pumping laser light beams emitted from the semiconductor lasers 11a-11c are injected into the solid-state laser crystal 13 via the focusing microlens array 12.

Upon incoming of the pumping laser light beams from the semiconductor lasers 11a-11c to the solid-state laser crystal 13, there is caused optical excitation in the laser crystal 13 of the microchip construction, and laser oscillation is caused at the respective wavelengths of 1319 nm, 1064 nm and 946 nm in the laser cavities 15a-15c.

Thereby, respective laser beams emitted from the microchip lasers formed by the surface coatings 16a-16c are incident to the Mg:LiNbO₃ crystals 14a-14c and converted therein to the SHG output laser beams.

In this way, the preset embodiment enables plural laser outputs of different wavelengths while using a single solid-state laser crystal 13, and it becomes possible to obtain high quality laser output with high power.

Further, because there are disposed non-linear optical crystals 14a-14c formed with the periodic structure of polarization reversal outside the laser cavities 15a-15c, the laser beams thus formed is converted to the laser beams of shorter wavelengths, and it becomes possible to realize a multiple-wavelength optical source of short wavelength band. Further, because of the use of the periodic polarization reversal structure, the characteristics of the non-linear optical crystal 14 are stabilized, and a solid-state laser of stabilized characteristics is provided with low cost. Thereby, stabilization of laser output and reduction of the cost can be attained at the same time.

Further, because of the construction that uses different semiconductor lasers 11a-11c for the pumping optical source in correspondence to the laser cavities 15a-15c, and because the output pumping laser beams of the semiconductor lasers 11a-11c are focused by the microlenses 12a-12c, the efficiency of focusing the pumping laser beams is improved. Further, as a result of use of the microlens array 12 for the focusing, the size of the laser apparatus is reduced at the same time.

### EXAMPLE 7

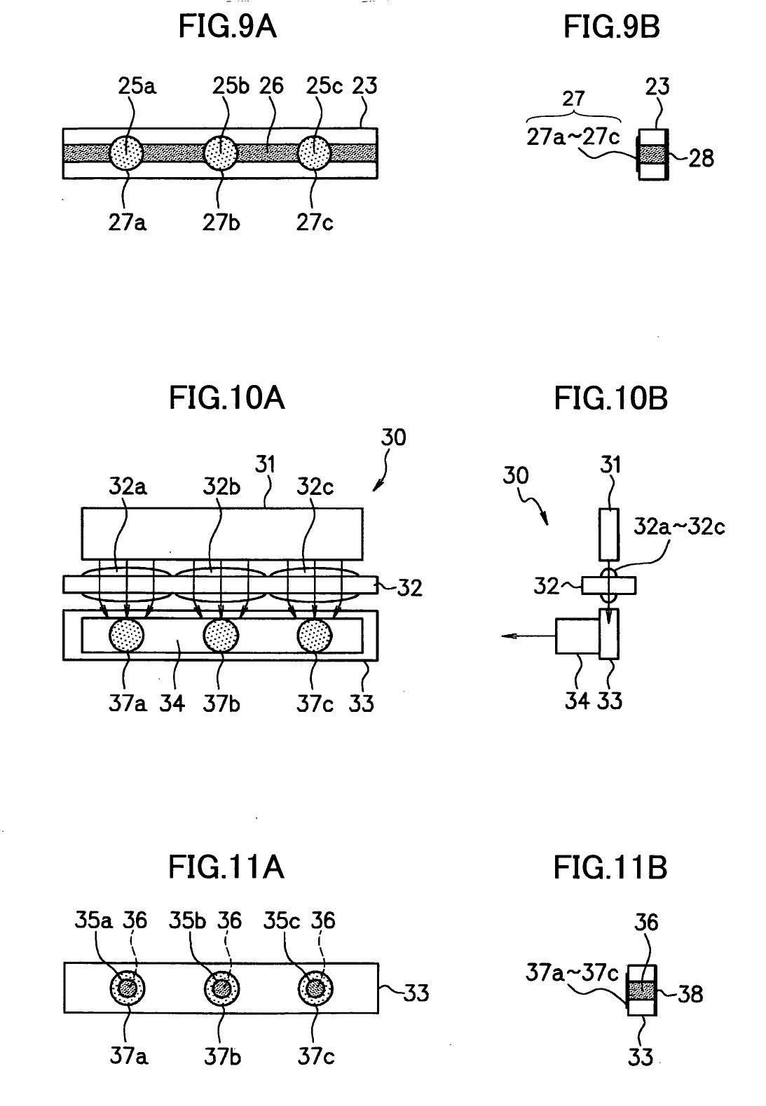

Next, Example 7 will be explained with reference to FIGS. 8A-8B and 9A-9B, wherein the laser apparatus of the present embodiment is used for a multiple-wavelength laser optical source and FIG. 8A shows the solid-state laser apparatus of the present embodiment in a front view while FIG. 8B shows the same laser apparatus in a side view. Further, FIGS. 9A and 9B show the solid-state laser medium used in the solid-state laser of FIG. 8A respectively in a front view and a side view.

Referring to the drawings, a solid-state laser apparatus 20 of the present embodiment comprises three semiconductor laser elements 21a-21c, a microlens array 22 including microlenses 22a-22c in correspondence to the laser elements 21a-21c, a single solid-state laser crystal (solid-state layer medium) 23 and a non-linear optical crystal (non-linear optical element or wavelength conversion element) 24. Further, three cavities 25a-25c of different oscillation wavelength conditions are provided on the foregoing single solid-state laser crystal 23.

Here, each of the semiconductor laser elements 21a-21c comprises a laser diode that causes single-mode laser oscillation at the wavelength of 808 nm with the maximum power of about 2 W. On the other hand, the microlens array 22 is formed of a quartz glass and focuses the laser beams of the laser elements 21a-21c such that the beam waists thereof are located generally at the center of the laser cavities 25a-25c, respectively.

For the solid-state laser crystal 23, a composite YAG crystal is used in which there is formed a YAG crystal region 26 doped with Nd at the central part and the YAG crystal region 26 thus formed is surrounded by a non-doped YAG crystal. In the present example, the Nd concentration in the Nd-doped YAG crystal region 26 is set to 1.0 at %. The composite solid-state laser crystal 23 may have a size of 3 mm in the width, 10 mm in the length and 0.8 mm in the thickness, and the Nd-doping is made to the central band-like region with the width of 1 mm. The sidewall surfaces and end surfaces of the crystal 23 are subjected to optical degree polishing.

On the front and rear surfaces of the solid-state laser crystal 23, there are provided dielectric surface coatings 27 and 28 as shown in FIGS. 9A and 9B, wherein the coating 28 at the rear surface of the solid-state laser crystal 23 is formed on the entire surface thereof so as to provide high reflectivity (99.9% or higher) at the wavelengths of the Nd:YAG crystal of 1319 nm, 1064 nm and 946 nm.

On the other hand, with regard to the surface coating 27 of the solid-state laser crystal 23, there are formed three distinct coating areas 27a-27c as shown in FIG. 9A, and in correspondence to these, there are formed three laser cavities 25a-25c with different oscillation wavelength conditions.

Here, it should be noted that the coating 27a at the front side of the solid-state laser crystal 23 is tuned to the laser oscillation at the wavelength of 1319 nm (reflectivity of about 98% for the wavelength of 1319 nm and transmissivity of about 100% for the wavelengths of 1064 nm and 946 nm). On the other hand, the coating 27b at the front side of the solid-state laser crystal 23 is tuned to the laser oscillation at the wavelength of 1064 nm (reflectivity of about 98% for the wavelength of 1064 nm; transmissivity of about 100% for the wavelengths of 1319 nm and 946 nm), and the coating 27c at the front side of the solid-state laser crystal 23 is tuned to the laser oscillation at the wavelength of 946 nm (reflectivity of about 98% for the wavelength of 946 nm; transmissivity of about 100% for the wavelengths of 1319 nm and 1064 nm).

The non-linear optical crystal 24 comprises a Mg:LiNbO₃ crystal formed with a periodic polarization reversal structure. In the present example, the crystal 24 has an aperture of 2 mm×3 mm and a thickness of 2 mm. The periodic reversal polarization is formed in the direction perpendicular to the output direction of the laser beam. In order to obtain the second harmonic (SHG) output for each of the laser outputs of the respective laser cavities 25a-25c, the period of polarization reversal is set to 12.9 μm for the output wavelength of 1319 nm, 7.0 μm for the output wavelength of 1064 nm and 4.8 μm for the output wavelength of 946 nm. Thereby, the LiNbO₃ crystal 24 is disposed outside the cavities 25a-25c on the optical path of the exiting laser beams.

In operation, the pumping laser light beams emitted from the semiconductor lasers 21a-21c are injected into the solid-state laser crystal 23 via the focusing microlens array 22.

Upon incoming of the pumping laser light beams from the semiconductor lasers 21a-21c to the solid-state laser crystal 23, there is caused optical excitation in the laser crystal 23 of the microchip construction in the area 26 thereof doped with Nd, and laser oscillation is caused at the respective wavelengths of 1319 nm, 1064 nm and 946 nm in the laser cavities 25a-25c.

Thereby, respective laser beams emitted from the microchip lasers are incident to the Mg:LiNbO₃ crystal 24, in which the periodic polarization reversal is formed in correspondence to each of the laser beams, and are converted therein to the SHG output laser beams.

In this way, the preset embodiment enables plural laser outputs of different wavelengths while using a single solid-state laser crystal 23, and it becomes possible to obtain high quality laser output with high power.

Further, by changing the doping concentration in correspondence to the laser cavities 25a-25c, it becomes possible to eliminate excessive absorption of the pumping light beams, and the efficiency of mode matching between the laser oscillation light and the pumping light beams is improved. Thereby, it becomes possible to improve the energy efficiency such as pumping efficiency or heat dissipation efficiency needed for the laser oscillation.

Further, because there is disposed a single non-linear optical crystal 24 formed with respective, different periodic structures of polarization reversal, outside the laser cavities 25a-25c, the laser beams thus formed is converted to the laser beams of shorter wavelengths, and it becomes possible to provide a laser apparatus in which the characteristics of the non-linear crystal 24 are stabilized.

With this, a solid-state laser of stabilized characteristics is provided with low cost. Further, as a result of the construction that uses the semiconductor lasers 21a-21c for the pumping optical sources in correspondence to the laser cavities 25a-25c and by focusing the laser beams by the microlenses 22a-22c, the efficiency of focusing of the laser beams is improved and it becomes possible to improve the laser output efficiency. Further, because of the use of the microlens array 22, it is possible to reduce the size of the apparatus.

### EXAMPLE 8

Next, Example 8 will be explained with reference to FIGS. 10A-10B and 11A-11B, wherein the laser apparatus of the present embodiment is used for a multiple-wavelength laser optical source and FIG. 10A shows the solid-state laser apparatus of the present embodiment in a front view while FIG. 10B shows the same laser apparatus in a side view. Further, FIGS. 11A and 11B show the solid-state laser medium used in the solid-state laser of FIG. 10A respectively in a front view and a side view.

Referring to the drawings, a solid-state laser apparatus 30 of the present embodiment comprises a single semiconductor laser array 31, a microlens array 32 including microlenses 32a-32c in correspondence to the plural laser diode elements formed inside the semiconductor laser array 31, a single solid-state layer medium 33 and a non-linear optical crystal (non-linear optical element or wavelength conversion element) 24. Further, three cavities 35a-35c of different oscillation wavelength conditions are provided on the foregoing single solid-state laser medium 33.

Here, a laser diode array producing the laser output at the wavelength of 808 nm with the power of about 10 W is used for the semiconductor laser array 31. The microlens array 32 is formed of a quartz glass and focuses the laser beams of the laser diode elements (three in the present case) such that the beam waists thereof are located generally at the center of the laser cavities 35a-35c, respectively.

For the solid-state laser medium 33, a YAG ceramic 36 is used in which there is formed an Nd-doped region 36 at the central part and the Nd-doped YAG region 36 thus formed is surrounded by a non-doped YAG crystals forming the ceramic 33. In the present example, the Nd concentration in the Nd-doped region 36 is set to 1.0 at %. The solid-state laser medium 33 of such a construction typically has the size of 3 mm in the width, 10 mm in the length and 0.8 mm in the thickness, and the Nd-doping is made in the region 36 to have a diameter of 1 mm. The sidewall surfaces and end surfaces of the solid-state laser medium 33 are all subjected to optical degree polishing.

On the front and rear surfaces of the solid-state laser medium 33, there are provided dielectric surface coatings 37 and 38 as shown in FIGS. 11A and 11B, wherein the coating 38 at the rear surface of the solid-state laser medium 33 is formed on the entire surface thereof so as to provide high reflectivity (99.9% or higher) at the wavelengths of the Nd:YAG crystal of 1319 nm, 1064 nm and 946 nm.

On the other hand, with regard to the surface coating 37 of the solid-state laser medium 33, there are formed three distinct coating areas 37a-37c as shown in FIG. 11A, and in correspondence to these, there are formed three laser cavities 35a-35c with different oscillation wavelength conditions.

Here, it should be noted that the coating 37a at the front side of the solid-state laser medium 33 is tuned to the laser oscillation at the wavelength of 1319 nm (reflectivity of about 98% for the wavelength of 1319 nm and transmissivity of about 100% for the wavelengths of 1064 nm and 946 nm). On the other hand, the coating 37b at the front side of the solid-state laser medium 33 is tuned to the laser oscillation at the wavelength of 1064 nm (reflectivity of about 98% for the wavelength of 1064 nm; transmissivity of about 100% for the wavelengths of 1319 nm and 946 nm), and the coating 37c at the front side of the solid-state laser medium 33 is tuned to the laser oscillation at the wavelength of 946 nm (reflectivity of about 98% for the wavelength of 946 nm; transmissivity of about 100% for the wavelengths of 1319 nm and 1064 nm).

Further, the non-linear optical crystal 34 comprises a Mg:LiNbO₃ crystal formed with a periodic polarization reversal structure. In the present example, the crystal 34 has an aperture of 2 mm×3 mm and a thickness of 2 mm. The periodic reversal polarization is formed in the direction perpendicular to the output direction of the laser beam. In order to obtain the second harmonic (SHG) output for each of the laser outputs of the respective laser cavities 35a-35c, the period of polarization reversal is set to 12.9 μm for the output wavelength of 1319 nm, 7.0 μm for the output wavelength of 1064 nm and 4.8 μm for the output wavelength of 946 nm. Thereby, the LiNbO₃ crystal 34 is disposed outside the cavities 35a-35c on the optical path of the exiting laser beams.

In operation, the pumping laser light beams emitted from the semiconductor laser array 31 are injected into the solid-state laser medium 33 via the focusing microlens array 32.

Upon incoming of the pumping laser light beams from the semiconductor laser array 31 to the solid-state laser medium 33, there is caused optical excitation in the laser medium 33 of the microchip construction in the area 36 thereof doped with Nd, and laser oscillation is caused at the respective wavelengths of 1319 nm, 1064 nm and 946 nm in the laser cavities 35a-35c.

Thereby, respective laser beams emitted from the microchip lasers are incident to the Mg:LiNbO₃ crystal 34, in which the periodic polarization reversal is formed in correspondence to each of the laser beams, and are converted therein to the SHG output laser beams.

In this way, the preset embodiment enables plural laser outputs of different wavelengths while using single solid-state laser medium 33, and it becomes possible to obtain high quality laser output with high power.

Further, by using a polycrystalline material for the solid-state laser medium 33 and by changing the concentration of the dopant causing the laser oscillation in correspondence to the laser cavities 35a-35c, the efficiency of mode matching between the laser oscillation light and the pumping light beams is improved. Thereby, it becomes possible to improve the energy efficiency such as pumping efficiency or heat dissipation efficiency needed for the laser oscillation. Further, it becomes possible to reduce the cost of the material by using the ceramic material for the solid-state laser medium 33.

Further, because there is disposed a single non-linear optical crystal 34 formed with respective, different periodic structures of polarization reversal, outside the laser cavities 35a-35c, the laser beams thus formed is converted to the laser beams of shorter wavelengths, and it becomes possible to provide a laser apparatus in which the characteristics of the non-linear crystal 34 are stabilized with low cost.

With this, a solid-state laser of stabilized characteristics is provided with low cost. Further, as a result of the construction that uses more than one semiconductor layer arrays 31 for the pumping optical source and by focusing the laser beams thus produced by the microlenses 32a-32c, the efficiency of focusing of the laser beams is improved, and it becomes possible to improve the laser output efficiency with increase of the pumping laser power. Further, because of the use of the microlens array 32, it is possible to reduce the size of the apparatus.

### EXAMPLE 9

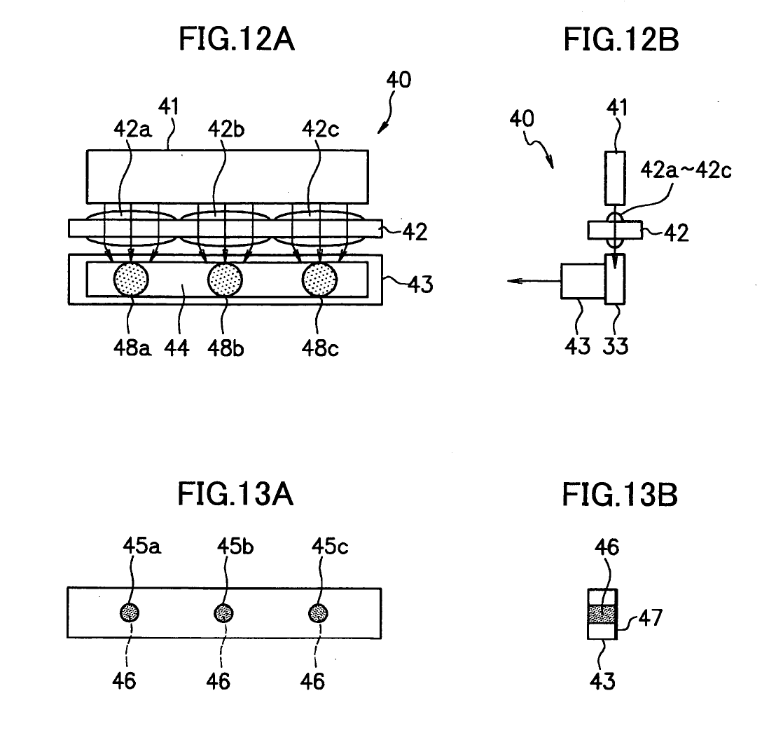

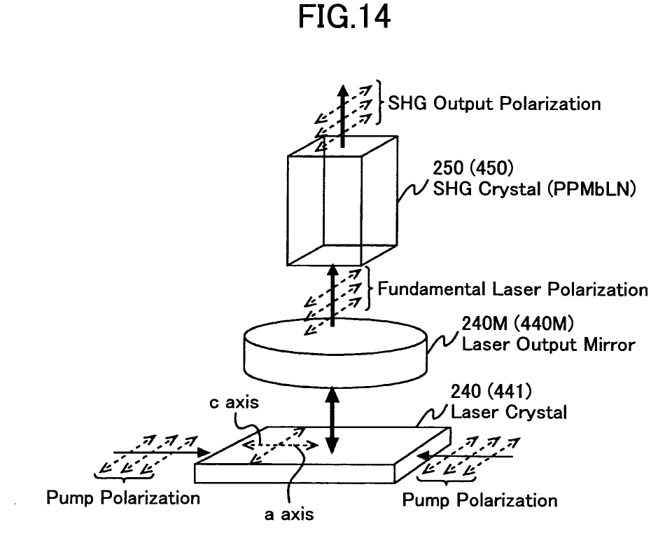

Next, Example 9 will be explained with reference to FIGS. 12A-12B and 13A-13B, wherein the laser apparatus of the present embodiment is used for a multiple-wavelength laser optical source and FIG. 12A shows the solid-state laser apparatus of the present embodiment in a front view while FIG. 12B shows the same laser apparatus in a side view. Further, FIGS. 13A and 13B show the solid-state laser medium used in the solid-state laser of FIG. 12A respectively in a front view and a side view.

Referring to the drawings, a solid-state laser apparatus 40 of the present embodiment comprises a single semiconductor laser array 41 for pumping, a microlens array 42 including microlenses 42a-42c in correspondence to the plural laser diode elements formed inside the semiconductor laser array 41, a single solid-state layer medium 43 and a non-linear optical crystal (non-linear optical element or wavelength conversion element) 44. Further, three cavities 45a-45c of different oscillation wavelength conditions are provided on the foregoing single solid-state laser medium 43.

Here, a laser diode array producing the laser output at the wavelength of 808 nm with the power of about 10 W is used for the semiconductor laser array 41. The microlens array 42 is formed of a quartz glass and focuses the laser beams of the laser diode elements (three in the present case) emitted from the semiconductor laser array 41 such that the beam waists thereof are located generally at the center of the laser cavities 45a-45c, respectively.

For the solid-state laser medium 43, a YAG ceramic is used in which a YAG ceramic 46 doped with Nd is disposed at the central part and the Nd-doped YAG region 46 thus formed is surrounded by a non-doped YAG crystals. In the present example, the Nd concentration in the Nd-doped region 46 is set to 1.0 at %. The solid-state laser medium 43 of such a construction typically has the size of 3 mm in the width, 10 mm in the length and 0.8 mm in the thickness, and the Nd-doping is made in the region 46 to have a diameter of 1 mm. The sidewall surfaces and end surfaces of the solid-state laser medium 43 are all subjected to optical degree polishing.

On the rear surface of the solid-state laser medium 43, there is provided a dielectric surface coating 47 as shown in FIG. 13A, wherein the coating 47 at the rear surface of the solid-state laser medium 43 is formed on the entire surface thereof so as to provide high reflectivity (99.9% or higher) at the wavelengths of the Nd:YAG crystal of 1319 nm, 1064 nm and 946 nm. On the other hand, no dielectric coating is provided at the front side of the solid-state laser medium 43.

Further, the non-linear optical crystal 44 comprises a Mg:LiNbO₃ crystal formed with a periodic polarization reversal structure. In the present example, the crystal 44 has an aperture of 2 mm×3 mm and a thickness of 2 mm. The periodic reversal polarization is formed in the direction perpendicular to the output direction of the laser beam. In order to obtain the second harmonic (SHG) output for each of the laser outputs of the respective laser cavities 45a-45c, the period of polarization reversal is set to 12.9 μm for the output wavelength of 1319 nm, 7.0 μm for the output wavelength of 1064 nm and 4.8 μm for the output wavelength of 946 nm. Thereby, the LiNbO₃ crystal is disposed inside the cavities 45a-45c such that the respective periodic structures are located in the corresponding cavities 45a-45c.

Further, in order to form laser cavities 45a-45c of respective, different oscillation wavelength conditions, there are formed dielectric coatings 48a-48c on the non-linear optical crystal 44 such that the coating 48a tuned to the oscillation wavelength of 1319 nm has a reflectivity of about 98% for the wavelength of 1319 nm and transmissivity of about 100% for the wavelengths of 1064 nm and 946 nm, while the coating 48b tuned to the oscillation wavelength of 1064 nm has a reflectivity of about 98% for the wavelength of 1064 nm and transmissivity of about 100% for the wavelengths of 1319 nm and 946 nm. Further, the coating 48c tuned to the oscillation wavelength of 946 nm has a reflectivity of about 98% for the wavelength of 946 nm and transmissivity of about 100% for the wavelengths of 1319 nm and 1064 nm.

In operation, the pumping laser light beams emitted from the semiconductor laser array 41 are injected into the solid-state laser medium 43 via the focusing microlens array 42.

Upon incoming of the pumping laser light beams to the solid-state laser medium 43, there is caused optical excitation in the laser medium 43 of the microchip construction in the area 46 thereof doped with Nd, and laser oscillation is caused at the respective wavelengths of 1319 nm, 1064 nm and 946 nm in the laser cavities 45a-45c.

In the present embodiment, in which the non-linear optical crystal 44 is disposed inside the optical cavities 45a-45c, there occurs wavelength conversion by utilizing the high optical power inside the optical cavity, and an SHG output is obtained as an output laser beam.

In this way, the preset embodiment enables plural laser outputs of different wavelengths while using single solid-state laser medium 43, and it becomes possible to obtain high quality laser output with high power.

Further, by using a polycrystalline material for the solid-state laser medium 43 and by changing the concentration of the dopant causing the laser oscillation in correspondence to the laser cavities 45a-45c, the efficiency of mode matching between the laser oscillation light and the pumping light beams is improved. Thereby, it becomes possible to improve the energy efficiency such as pumping efficiency or heat dissipation efficiency needed for the laser oscillation. Further, it becomes possible to reduce the cost of the material by using the ceramic material for the solid-state laser medium 43.

Further, because there is disposed a single non-linear optical crystal 44 formed with respective, different periodic structures of polarization reversal, inside the laser cavities 45a-45c, the laser beams thus formed is converted to the laser beams of shorter wavelengths, and it becomes possible to provide a laser apparatus in which the characteristics of the non-linear crystal 44 are stabilized with low cost.

With this, a solid-state laser of stabilized characteristics is provided with low cost. Further, as a result of the construction that uses more than one semiconductor layer arrays 41 for the pumping optical source and by focusing the laser beams thus produced by the microlenses 42a-42c, the efficiency of focusing of the laser beams is improved, and it becomes possible to improve the laser output efficiency with increase of the pumping laser power. Further, because of the use of the microlens array 42, it is possible to reduce the size of the apparatus.

Further, the present invention is by no means limited to the materials or constructions explained heretofore with reference to examples but various modifications are possible within the scope of the invention.

For example, the pumping semiconductor laser may be changed depending on the absorption wavelength of the laser crystal. Further, it is possible to pump the laser oscillation in the case of using a medium doped with Nd while using a semiconductor laser of the wavelength of about 880 nm.

Further, while the embodiment explained heretofore used YAG or GdVO₄ for the laser crystal, it is also possible to use YVO₄ or LSB for this purpose.

Further, it is also possible to use various bulk crystals such as KTP or LBO or other polarization reversal devices formed on the LiTaO₄ crystal for the non-linear optical crystal.

Further, while the explained embodiments used the construction of injecting the pumping lasers into the laser crystal from one direction or two directions, it is also possible to achieve laser excitation from different directions.

Further, while the present embodiment have proposed the use of two microlens for the optical elements cooperating with the semiconductor laser arrays, the present invention is not limited to such a construction and it is possible to reduce or increase the number of the microlenses.

Further, the present invention is by no means limited to the embodiments described heretofore, but various variations and modifications may be made without departing from the scope of the invention.

The present invention is based on the Japanese priority applications 2004-098117 filed on Mar. 30, 2004, 2004-194594 filed on Jun. 30, 2004, 2005-023354 filed on Jan. 31, 2005 and 2005-064649 filed on Mar. 8, 2005, the entire contents of which are incorporated herein as reference.

1. A solid-state laser apparatus, comprising:
a solid-state laser medium producing an output laser beam, said solid-state laser medium forming a microchip laser and having opposing end surfaces forming a laser cavity;
a semiconductor laser array pumping said solid-state laser medium by a pumping laser beam,
said semiconductor laser array injecting said pumping laser beam to said solid-state laser medium from a direction perpendicular to a direction of said output laser beam,
said solid-state laser medium and said semiconductor laser array are mounted on a common mounting substrate.

2. The solid-state laser apparatus as claimed in claim 1, wherein said solid-state laser medium is provided on said mounting substrate in plural numbers, said plural solid-state laser media producing said output laser beams with respective, different wavelengths.

3. The solid-state laser apparatus as claimed in claim 1, wherein said solid-state laser medium includes therein plural microchip lasers, said plural microchip lasers producing output laser beams with respective, different wavelengths.

4. The solid-state laser apparatus as claimed in claim 1, in which said solid-state laser medium includes a doped region doped with an impurity element needed for laser oscillation and a non-doped region not doped with said impurity element.

5. The solid-state laser apparatus as claimed in claim 4, wherein said solid-state laser medium is formed of a single monocrystalline material.

6. The solid-state laser apparatus as claimed in claim 4, wherein said composite solid-state laser medium comprises a single ceramic material.

7. The solid-state laser apparatus as claimed in claim 4, wherein said doped region comprises a monocrystalline material and said non-doped region comprises a ceramic material.

8. The solid-state laser apparatus as claimed in claim 4, wherein said doped region comprises a ceramic material and said non-doped region comprises a monocrystalline material, said doped region and said non-doped region being formed either of a common material or different materials.

9. The solid-state laser apparatus as claimed in claim 1, wherein said output laser beam of said microchip laser comprises said pumping laser beam of said semiconductor laser array injected to said solid-state laser medium after dividing by an optical element.

10. The solid-state laser apparatus as claimed in claim 1, wherein said semiconductor laser array is provided in plural numbers, said plural semiconductor laser arrays producing plural pumping laser beams as said pumping laser beam, said output laser beam of said microchip laser comprises said pumping laser beams of said semiconductor laser arrays injected to said solid-state laser medium after dividing by an optical element.

11. The solid-state laser apparatus as claimed in claim 1, further comprising a non-linear optical element in an optical path of said output laser beam for wavelength conversion.

12. The solid-state laser apparatus as claimed in claim 11, wherein said non-linear optical element comprises a wavelength conversion element of quasi-phase matching type.

13. The solid-state laser apparatus as claimed in claim 12, wherein said wavelength conversion element has a region capable of wavelength conversion to said output laser beam of said microchip laser.

14. The solid-state laser apparatus as claimed in claim 2, wherein at least two of red, green and blue laser beams are obtained as said output laser beams of said microchip lasers.

15. The solid-state laser apparatus as claimed in claim 1, wherein said solid-state laser medium comprises a material that changes an absorption coefficient and a cross-sectional area of stimulated emission according to crystal axes, said solid-state laser medium further being a material producing said output laser beam in the form of a linearly polarized light.

16. The solid-state laser apparatus as claimed in claim 15, wherein a polarization direction of said pumping laser beam is coincident with a crystal axis of said solid-state laser medium that provides a large absorption coefficient, said polarization direction being parallel with a principal surface of said mounting substrate.

17. The solid-state laser apparatus as claimed in claim 16, wherein said pumping laser beams of said semiconductor laser array is incident to said solid-state laser medium from two, opposite directions across said solid-state laser medium.
